(19) United States
(12) Patent Application Publication
(10) Pub. No.: US 2024/0278998 A1
(43) Pub. Date: Aug. 22, 2024

(54) BRAKE ASSEMBLY OF ELONGATED ASSEMBLIES

(71) Applicant: Thor Global Enterprises Ltd., Mississauga (CA)

(72) Inventors: Torben Johannsen, Mississauga (CA); Doug Montenegro, Etobicoke (CA)

(21) Appl. No.: 18/437,851

(22) Filed: Feb. 9, 2024

Related U.S. Application Data
(60) Provisional application No. 63/490,393, filed on Mar. 15, 2023.
(60) Provisional application No. 63/485,713, filed on Feb. 17, 2023.

(51) Int. Cl. B65G 43/06

(52) U.S. Cl. CPC B65G 43/06

(57) ABSTRACT

A brake assembly is provided for use with first and second elongated assemblies. The second elongated assembly may be movable, at least in part, along an elongated movement axis relative to the first elongated assembly. The brake assembly is configured to selectively securely engage first and second elongated assemblies together to halt relative movement between the first and second elongated assemblies.

### CROSS REFERENCE TO RELATED APPLICATIONS

This non-provisional application claims the benefit and the priority date of prior U.S. Provisional Application No. 63/485,713, filed Feb. 17, 2023 Feb. 17, 2023), entitled INNER CONVEYOR BRAKE SYSTEM WITH BRAKE PLATE, and the entire content of which is incorporated herein by reference. This non-provisional application is related to and claims domestic priority benefits under 35 USC § 119(e) from U.S. Provisional Patent Application Ser. No. 63/485,713 filed on Feb. 17, 2023 Feb. 17, 2023), and the entire content of which is expressly and hereby incorporated hereinto by reference. In addition, this non-provisional application also claims the benefit and the priority date of prior U.S. Provisional Application No. 63/490,393, filed Mar. 15, 2023 Mar. 15, 2023), entitled INNER CONVEYOR BRAKE SYSTEM WITH BRAKE PLATE, and the entire content of which is incorporated herein by reference. This non-provisional application is also related to and claims domestic priority benefits under 35 USC § 119(e) from U.S. Provisional Patent Application Ser. No. 63/490,393 filed on Mar. 15, 2023 Mar. 15, 2023), and the entire content of which is expressly and hereby incorporated hereinto by reference.

### TECHNICAL FIELD

This document relates to the technical field of (and is not limited to) (A) a brake assembly for synergistic use with, and/or synergistic installation to, first and second elongated assemblies; and/or (B) at least one or more components of a brake assembly for synergistic use with, and/or synergistic installation to, first and second elongated assemblies; and/or (C) a brake assembly in synergistic combination with first and second elongated assemblies; and/or (D) a method including synergistic steps of operation of a brake assembly in combination with first and second elongated assemblies.

### BACKGROUND

First and second elongated assemblies are configured to include, and/or may be configured to receive and support, respective first and second conveyor systems that are configured to move objects from a first location to a second location. For instance, the first and second conveyor systems may be configured to move objects that might be too heavy and/or too bulky for humans to carry by hand. The first and second elongated assemblies and the first and second conveyor systems synergistically cooperate to achieve the movement of objects from the first location to the second location.

### SUMMARY

It will be appreciated that there exists a need to mitigate (at least in part) at least one problem associated with the existing elongated assemblies (also called the existing technology). After much study and experimentation of the known systems and methods, an understanding (at least in part) of the problem and its solution have been identified (at least in part) and are articulated (at least in part) for the following major aspects as follows: the first elongated assembly is spatially positioned proximate to the first position in such a way that the input section of the first conveyor system (of the first elongated assembly) may receive material to be moved there along toward the output section of the first conveyor system. The second elongated assembly is positioned proximate to the second position in such a way that the input section of the second conveyor system (of the second elongated assembly) may receive material from the output of the first conveyor system, and the second conveyor system moves the material along to the output section of the second conveyor system so that the material may be placed at the second location. The first and second elongated assemblies are movable relative to each other. For instance, the first elongated assembly may be securely fixed to a working surface and is configured to support the movement of the second elongated assembly relative to the first elongated assembly. This is done in such a way that the second conveyor of the second elongated assembly may be spatially positioned at a new or a desired second position so that the material may be outputted (expelled) from the second conveyor at the (new) second position, etc. Unfortunately, relative movement between the elongated assemblies might lead to undesired consequences, such as the case where a moving system (extending and retracting means) of the second elongated assembly fails to operatively move the second elongated assembly in a safe and secure manner. For the case where an undesired condition is encountered, safe operational stoppage of relative movement between the elongated assemblies (which may include respective conveyors) is desired so that there is a reduction and/or avoidance of inadvertent equipment damage and/or injury to personnel, maintenance of ongoing operational efficiencies, minimization of unwanted costs for repairs, and/or equipment downtime. To reduce, at least in part, and/or preferably avoid (if possible) damage and/or injury to personnel, the inventors desire to provide at least one or more technical solutions, such as (A) a method of operating a brake assembly configured to stop (halt) relative movement between elongated assemblies operating under adverse conditions, and/or (B) a brake assembly configured to stop (halt) relative movement between elongated assemblies operating under adverse conditions, (C) a sub-system of a brake assembly configured to stop (halt) relative movement between elongated assemblies operating under adverse conditions (once the sub-system is synergistically combined with another sub-system), and/or (D) elongated assemblies having a brake assembly configured to stop (halt) relative movement between elongated assemblies.

To mitigate, at least in part, at least one problem associated with the existing technology, there is provided—in accordance with a first major aspect—a brake assembly configured to selectively securely engage first and second elongated assemblies together to thereby halt relative movement between the first and second elongated assemblies, preferably in response to the detection of an undesired operational condition that is detectable (such as, detectable by a sensor or any equivalent, etc.).

To mitigate, at least in part, at least one problem associated with the existing technology, there is provided—in accordance with a second major aspect—an apparatus, in which the apparatus includes, and is not limited to, the following synergistic combination of technical features: (A) a first elongated assembly, and (B) a second elongated assembly configured to be movable, at least in part, along an elongated movement axis relative to the first elongated assembly, and (C) a brake assembly which may include, and is not limited to, a synergistic combination of (A) spaced-apart engagement features and (B) a complementary engagement feature, etc. It will be appreciated that in accordance with a preferred embodiment, the brake assembly may include the complementary engagement feature, in which case the spaced-apart engagement features may be provided by the end user (if so desired) and installed the any one of the first and second elongated assemblies. The brake assembly is configured to selectively securely engage the first elongated assembly and the second elongated assembly together to thereby halt, at least in part, relative movement between the first elongated assembly and the second elongated assembly. The brake assembly includes brake features which are serially positionable (preferably one after another) in a spaced-apart close intimate arrangement. The brake features of the brake assembly are also coaxially alignable, at least in part, along the elongated movement axis.

To mitigate, at least in part, at least one problem associated with the existing technology, there is provided—in accordance with a third major aspect—an apparatus, in which the apparatus includes, and is not limited to, the following synergistic combination of technical features: (A) a first elongated assembly, (B) a second elongated assembly that is movable, at least in part, along an elongated movement axis, relative to the first elongated assembly, and (C) a brake assembly that includes (and is not limited to) spaced-apart engagement features. The spaced-apart engagement features include (and is not limited to) a selectable engagement feature. The spaced-apart engagement features also include (and is not limited to) engagement features that are serially positionable, one after another, in a spaced-apart close intimate arrangement (preferably one after the other). The spaced-apart engagement features are coaxially alignable, at least in part, along the elongated movement axis. The first elongated assembly and the second elongated assembly are selectively securely engageable together at the selectable engagement feature to thereby halt, at least in part, relative movement between the second elongated assembly and the first elongated assembly.

To mitigate, at least in part, at least one problem associated with the existing technology, there is provided—in accordance with a fourth major aspect—an apparatus, in which the apparatus includes, and is not limited to, the following synergistic combination of technical features: a first elongated assembly having first structural members. The first elongated assembly also has an elongated longitudinal axis extending along an elongated length of the first elongated assembly. A second elongated assembly has second structural members. The second elongated assembly is configured to be movable relative to the first elongated assembly along an elongated movement axis. The second elongated assembly is also configured to be coaxially alignable relative to the elongated longitudinal axis of the first elongated assembly. A brake assembly includes (and is not limited to) spaced-apart engagement features. The spaced-apart engagement features include a selectable engagement feature. The spaced-apart engagement features has engagement features that are configured to be coaxially alignable, at least in part, relative to the elongated movement axis. The spaced-apart engagement features are also configured to be serially positionable, one after another, in a spaced-apart close intimate arrangement along the second structural members of the second elongated assembly. The first elongated assembly and the second elongated assembly are selectively securely engageable (latchable) together at the selectable engagement feature to halt, at least in part, relative movement between the second elongated assembly and the first elongated assembly in response to the first elongated assembly and the second elongated assembly becoming selectively securely engaged at the selectable engagement feature.

To mitigate, at least in part, at least one problem associated with the existing technology, there is provided—in accordance with a fifth major aspect—an apparatus, in which the apparatus includes, and is not limited to, the following synergistic combination of technical features: a first elongated assembly having first structural members. The first elongated assembly also has an elongated longitudinal axis extending along an elongated length of the first elongated assembly. A second elongated assembly has second structural members. The second elongated assembly is configured to be extendable (preferably telescopically extendable) and movable relative to the first elongated assembly along an elongated movement axis. The elongated movement axis is coaxially aligned relative to the elongated longitudinal axis of the first elongated assembly. A brake assembly includes (and is not limited to) spaced-apart engagement features. The spaced-apart engagement features have (and are not limited to) a selectable engagement feature. The spaced-apart engagement features have (include and are not limited to) engagement features that are configured to be serially linearly securely located and positioned, at least in part, in a spaced-apart close intimate arrangement longitudinally along at least some of the second structural members of the second elongated assembly. The spaced-apart engagement features are also configured to be, at least in part, coaxially aligned relative to the elongated movement axis. The brake assembly also includes (and is not limited to) a complementary engagement feature configured to be securely supported by the first structural members of the first elongated assembly. The complementary engagement feature is selectively securely engageable to the selectable engagement feature of the spaced-apart engagement features. This is done in such a way that selective secured engagement of the complementary engagement feature with the selectable engagement feature, in use, halts, at least in part, relative movement between the second elongated assembly and the first elongated assembly.

To mitigate, at least in part, at least one problem associated with the existing technology, there is provided—in accordance with a sixth major aspect—an apparatus configured to be usable with a first elongated assembly. The apparatus is also usable with a second elongated assembly being movable, at least in part, along an elongated movement axis relative to the first elongated assembly. The apparatus includes (and is not limited to) the following synergistic combination of technical features: a brake assembly including (and not limited to) spaced-apart engagement features. The spaced-apart engagement features include (and are not limited to) a selectable engagement feature. The spaced-apart engagement features have (and are not limited to) engagement features that are serially positionable, one after another, in a spaced-apart close intimate arrangement. The spaced-apart engagement features are also coaxially alignable, at least in part, along the elongated movement axis. The brake assembly also includes (and is not limited) to a complementary engagement feature configured to be selectively securely engageable with the selectable engagement feature.

To mitigate, at least in part, at least one problem associated with the existing technology, there is provided—in accordance with a seventh major aspect—an apparatus usable with a first elongated assembly. The apparatus is also usable with a second elongated assembly that is movable, at least in part, along an elongated movement axis relative to the first elongated assembly. The apparatus is also usable with spaced-apart engagement features including and not limited to a selectable engagement feature. The spaced-apart engagement features are serially positionable, one after another, in a spaced-apart close intimate arrangement. The spaced-apart engagement features are also coaxially alignable, at least in part, along the elongated movement axis. The apparatus includes and is not limited to the following synergistic combination of technical features: a brake assembly including (and not limited to) a complementary engagement feature configured to be selectively securely engageable with the selectable engagement feature. The complementary engagement feature is also configured to halt, at least in part, relative movement between the second elongated assembly and the first elongated assembly. This halting action is achieved in response to selective secured engagement between the complementary engagement feature the selectable engagement feature.

To mitigate, at least in part, at least one problem associated with the existing technology, there is provided—in accordance with an eighth major aspect—an apparatus usable with a first elongated assembly. The apparatus is also usable with a second elongated assembly that is movable, at least in part, along an elongated movement axis relative to the first elongated assembly. The apparatus is also usable with a complementary engagement feature. The apparatus includes and is not limited to the following synergistic combination of technical features: a brake assembly including (and not limited to) spaced-apart engagement features including and not limited to a selectable engagement feature. The spaced-apart engagement features have (and are not limited to) engagement features that are serially positionable, one after another, in a spaced-apart close intimate arrangement. The spaced-apart engagement features are also coaxially alignable, at least in part, along the elongated movement axis. The complementary engagement feature is configured to be selectively securely engageable with the selectable engagement feature. The complementary engagement feature is also configured to halt, at least in part, relative movement between the second elongated assembly and the first elongated assembly. This halting action is achieved in response to selective secured engagement between the complementary engagement feature the selectable engagement feature.

To mitigate, at least in part, at least one problem associated with the existing technology, there is provided—in accordance with a ninth major aspect—an apparatus, in which the apparatus includes, and is not limited to, the following synergistic combination of technical features: a first elongated assembly having first structural members. The first elongated assembly also has an elongated longitudinal axis extending along an elongated length of the first elongated assembly. A second elongated assembly has second structural members. The second elongated assembly is configured to be extendable (preferably telescopically extendable) and movable relative to the first elongated assembly along an elongated movement axis. The elongated movement axis is coaxially aligned relative to the elongated longitudinal axis of the first elongated assembly. A brake assembly includes and is not limited to spaced-apart engagement features. The spaced-apart engagement features have (and are not limited to) a selectable engagement feature. The spaced-apart engagement features have engagement features that are configured to be serially linearly securely located and positioned, at least in part, in a spaced-apart close intimate arrangement longitudinally along at least some of the second structural members of the second elongated assembly. The spaced-apart engagement features are also configured to be, at least in part, coaxially aligned relative to the elongated movement axis (and/or the elongated longitudinal axis of the first elongated assembly). The spaced-apart engagement features include (and are not limited to): an elongated member configured to be attached, at least in part, to the second structural members of the second elongated assembly. The elongated member defines spaced-apart grooves aligned along an elongated length of the elongated member. The brake assembly also includes and is not limited to a complementary engagement feature configured to be securely supported by the first structural members of the first elongated assembly. The complementary engagement feature is selectively securely engageable to the selectable engagement feature of the spaced-apart engagement features. This is done in such a way that selective secured engagement of the complementary engagement feature with the selectable engagement feature, in use, halts, at least in part, relative movement between the second elongated assembly and the first elongated assembly. The complementary engagement feature is configured to apply a halting force to the selectable engagement feature. The complementary engagement feature is also configured to be coupled to a tension line. The complementary engagement feature includes (and is not limited to): (A) a first frame assembly that is configured to be fixedly attached to the first elongated assembly, and (B) a second frame assembly that is configured to be movable relative to the first frame assembly. The complementary engagement feature further includes (and is not limited to): a shaped member operatively mounted to the first frame assembly. The shaped member is configured to be movable into the selectable engagement feature. The shaped member is also configured to be movable out from the selectable engagement feature. The shaped member is pivotally mounted to the first frame assembly. The complementary engagement feature further includes (and is not limited to): an actuator assembly configured to actuate selective movement of the shaped member into, and out from, the selectable engagement feature. The actuator assembly includes (and is not limited to): a spring assembly configured to be selectively compressed and decompressed. The spring assembly is also configured to biasedly engage a portion of the complementary engagement feature with a portion of the selectable engagement feature. In response to increased tension in the tension line, the spring assembly becomes compressed to thereby securely engage the complementary engagement feature with the selectable engagement feature. In response to decreased tension in the tension line, the spring assembly becomes relaxed to thereby disengage the complementary engagement feature with the selectable engagement feature. The spring assembly is also configured to biasedly disengage the complementary engagement feature away from the selectable engagement feature in response to reduction in tension, at least in part, of the tension line; this is done in such a way that the spring assembly, in use, urges the complementary engagement feature away from the selectable engagement feature to permit relative movement between the first elongated assembly and the second elongated assembly. The spring assembly is also configured to securely biasedly engage the complementary engagement feature with the selectable engagement feature in response to an increase in tension of the tension line. This biasedly engage action is done in such a way that the spring assembly (in use) urges, in use, the complementary engagement feature to securely engage the selectable engagement feature to halt, at least in part, relative movement between the first elongated assembly and the second elongated assembly. The complementary engagement feature further includes (and is not limited to): a linkage assembly configured to link, either directly or indirectly, the complementary engagement feature with the spring assembly. The linkage assembly is also configured to urge movement of the complementary engagement feature away from the selectable engagement feature in response to reduction in tension of the tension line. The linkage assembly is also configured to securely engage, in cooperation with a spring assembly, the complementary engagement feature with the selectable engagement feature in response to an application of tension to the tension line.

To mitigate, at least in part, at least one problem associated with the existing technology, there is provided—in accordance with a tenth major aspect—a method of operating a first elongated assembly and a second elongated assembly that is movable relative to the first elongated assembly along an elongated movement axis, with a brake assembly, The brake assembly includes and is not limited to spaced-apart engagement features, and the spaced-apart engagement features include (and are not limited to) a selectable engagement feature. The spaced-apart engagement features are serially positionable one after another in a spaced-apart close intimate arrangement and coaxially alignable, at least in part, along the elongated movement axis. The method includes, and is not limited to, the following step: selectively securely engaging together at the selectable engagement feature of the brake assembly to thereby halt, at least in part, relative movement between the second elongated assembly and the first elongated assembly.

To mitigate, at least in part, at least one problem associated with the existing technology, there is provided—in accordance with an eleventh major aspect—a method, in which the method includes, and is not limited to, the following synergistic combination of technical steps: positioning a first elongated assembly; positioning a second elongated assembly that is movable relative to the first elongated assembly along an elongated movement axis; and serially positioning the spaced-apart engagement features of a brake assembly, in which the spaced-apart engagement features include and are not limited to a selectable engagement feature, and the spaced-apart engagement features are positioned one after another, in a spaced-apart close intimate arrangement (relationship) so that the spaced-apart engagement features are coaxially aligned, at least in part, along the elongated movement axis; and selectively securely engaging together at the selectable engagement feature to thereby halt, at least in part, relative movement between the second elongated assembly and the first elongated assembly.

To mitigate, at least in part, at least one problem associated with the existing technology, there is provided—in accordance with a twelfth major aspect—an apparatus, in which the apparatus includes, and is not limited to, the following synergistic combination of technical features: a first elongated assembly; and a second elongated assembly being movable, at least in part, along an elongated movement axis relative to the first elongated assembly; and a brake assembly being configured to selectively securely engage the first elongated assembly and the second elongated assembly together to thereby halt, at least in part, relative movement between the first elongated assembly and the second elongated assembly; and said brake assembly including brake features; at least some of said brake features being serially positionable, one after another, in a spaced-apart close intimate arrangement; and said at least some of said brake features also being coaxially alignable, at least in part, along said elongated movement axis.

Without reference to any specific drawings, the inventors have conducted many detailed studies of, including extensively prolonged experimentation with, the existing technology. The inventors have come to appreciate and understand at least some of the problems and some of the disadvantages associated with the uncontrolled movements of conveyor systems and/or structures that support these conveyor systems. After many technical struggles and trial-and-error experiments, the inventors have concluded that these problems may be solved with or by the current systems and/or current knowledge in the following manner: the current systems and/or current technology involves the usage of drop-pin mechanisms (known and not depicted) that are situated at the tail end section of an inner conveyor system (or a second conveyor) configured to be used (telescopically) with an outer conveyor system (a first conveyor). The drop-pin mechanisms are configured for use with a wire-rope winch system. The wire-rope winch system is configured to operate as the extending/retracting means for moving the inner conveyor relative to the outer conveyor. There is a triggering mechanism configured to react to the tension on (in) the supporting winch cable. In an under-tension cable scenario or a broken cable scenario, the triggering mechanism is configured to release the two drop pins that will catch (engage) onto the main structure of the outer conveyer thereby hating relative movement between the inner conveyor and the outer conveyor. The outer conveyor is the structure within which the inner conveyor telescopes and moves along the outer conveyor. It will be appreciated that the inner conveyor is movable between an inboard position (such as a fully inboard position) and an outboard position (such as, a fully outboard position). Moreover, the reliability of the current systems appear to be highly dependent on regular maintenance (ongoing reevaluation effort) of the pin-drop mechanisms so that the drop-pins operate correctly when needed (including possible material replacement or rehabilitation when needed). The inventors have developed an appreciation for the negative effects that result from the lack of attention to relatively poor maintenance, which may lead to an unwanted delayed reaction associated with the desired extension (movement) of the drop pins (at a desired time) that leads to a delay in stoppage—of relative movement of the elongated assemblies—that might occur undesirably later than intended or desired. This unwanted delay gives the inner conveyor (or the structure that directly supports the inner conveyor) more distance to (A) inadvertently gather increasing speed making the stopping impact unfortunately much greater and/or (B) inadvertently increase a higher likelihood that the drop pins might not engage properly and thereby permit unwanted or uncontrolled movement of the inner conveyor leading to a catastrophic collision event (such as, equipment damage and/or injury to personnel). For the case where the drop pins eventually manage to securely engage (to halt relative movement), the outer conveyor (which supports the inner conveyor) might become inadvertently damaged and may require structural repairs or work to make the entire machine (the combination of outer and inner conveyors) operationally safe. For the case where the drop pins do not engage at all (to halt relative movement), the inner conveyor and the outer conveyor will experience catastrophic failure resulting in extensive repair and labour to make the inner conveyor and the outer conveyor operationally safe. It will be appreciated that there are limitations and drawbacks of current technology and/or current systems. For instance, the current systems are designed to catch or stop relative movement of the inner conveyor (relative to the outer conveyor) within a four-foot distance, which is based on the internal brace spacing of the structural components of the outer conveyor. Depending on how well-maintained the pin-drop mechanism is, the drop pins may stop the relative movement of the inner conveyor over a longer run distance, which gives the inner conveyor more distance to gather speed and thereby make the catching impact undesirably greater. It will be appreciated that this case could lead to increased but unwanted damage, such as to the outer structure. Of course, any damage may require several resources for the repairs to be made, along with the lost productive time since the outer and inner conveyors are not operating. In either case (scenario), resetting the drop pins may require an additional resource-consuming task to ensure the outer and inner conveyors are structurally ready to be placed back into safe operation. The inventors have determined that the operators (workers) need, during repair work, to (A) ensure that the inner conveyor is securely braced against movement relative to the outer conveyor, (B) work up close to the drop-pin mechanism in such a way that the workers manually reset the drop pins, and reset the triggering mechanism (if any), and/or (C) remove the brace so that the inner conveyor may move relative to the outer conveyor without hindrance of relative movement.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify potentially key features or possible essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### DETAILED DESCRIPTION OF THE DRAWINGS

The non-limiting embodiments may be more fully appreciated by reference to the following detailed description of the non-limiting embodiments when taken in conjunction with the accompanying drawings, in which:

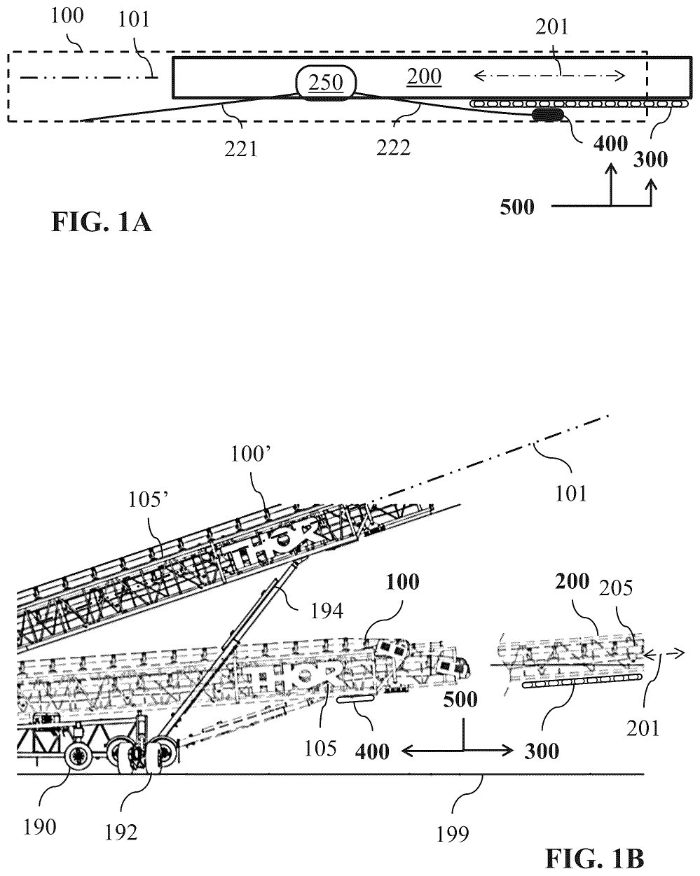

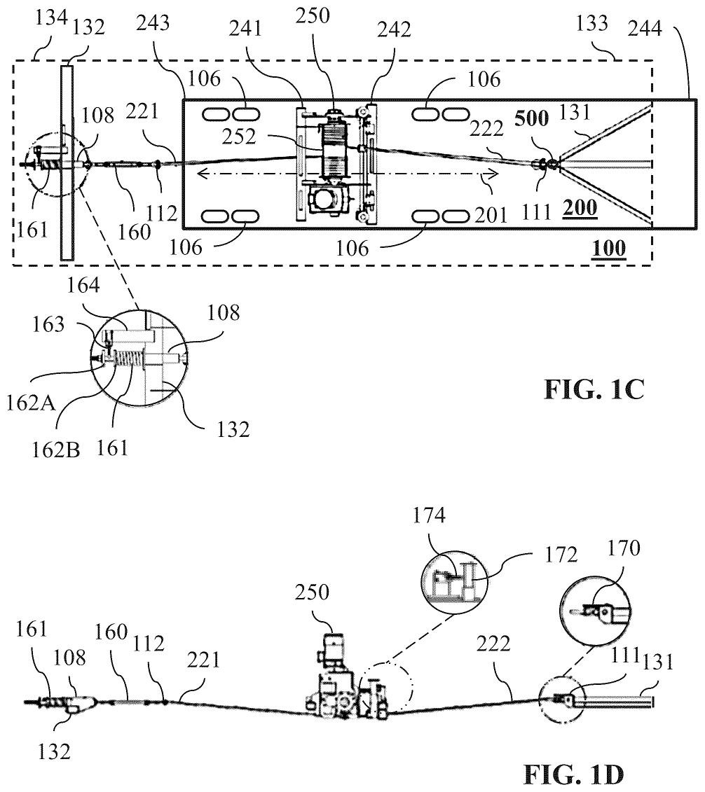

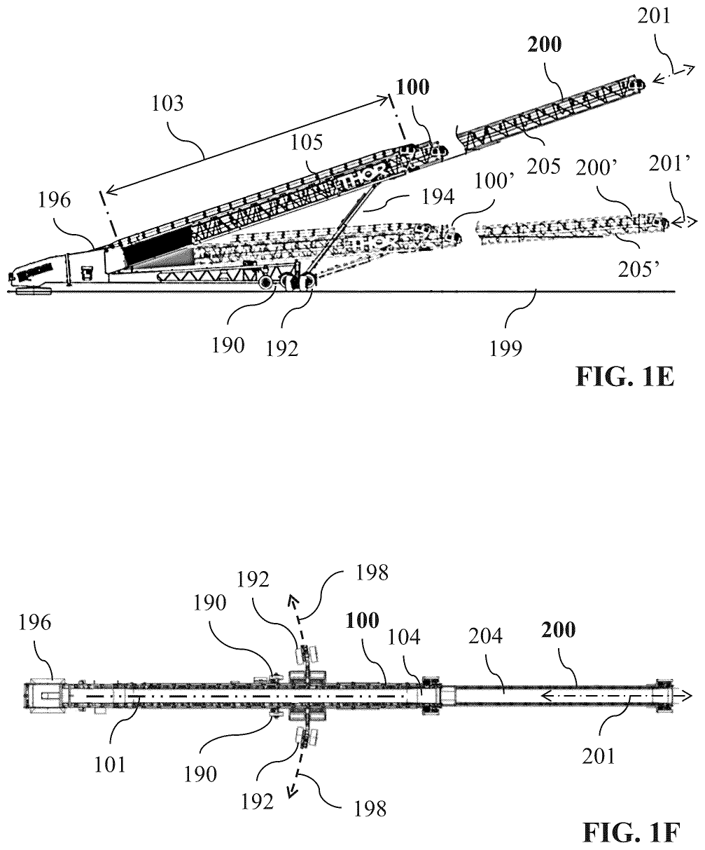

FIG. 1A and FIG. 1B depict side views of embodiments of a brake assembly for use with, or installable to, embodiments of first and second elongated assemblies; and

FIG. 1C and FIG. 1D depict a top view (FIG. 1C) and a side view (FIG. 1D) of embodiments of the first and second elongated assemblies of FIG. 1A; and

FIG. 1E and FIG. 1F depict a side view (FIG. 1E) and a top view (FIG. 1F) of embodiments of the first and second elongated assemblies of FIG. 1A; and

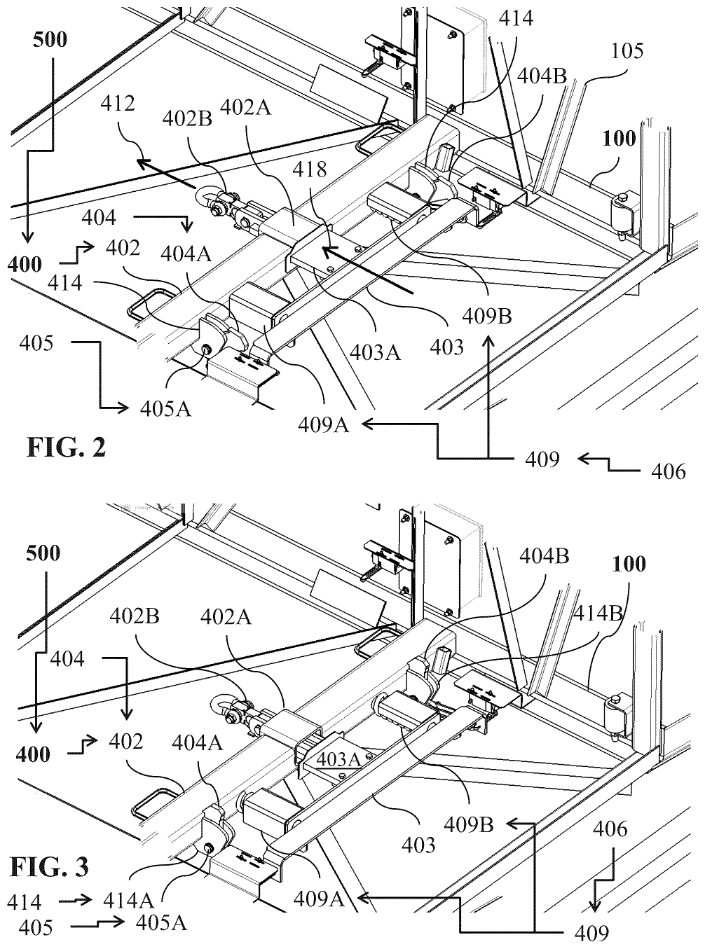

FIG. 2 and FIG. 3 depict perspective views of embodiments of the brake assembly of any one of FIG. 1A and/or FIG. 1B; and

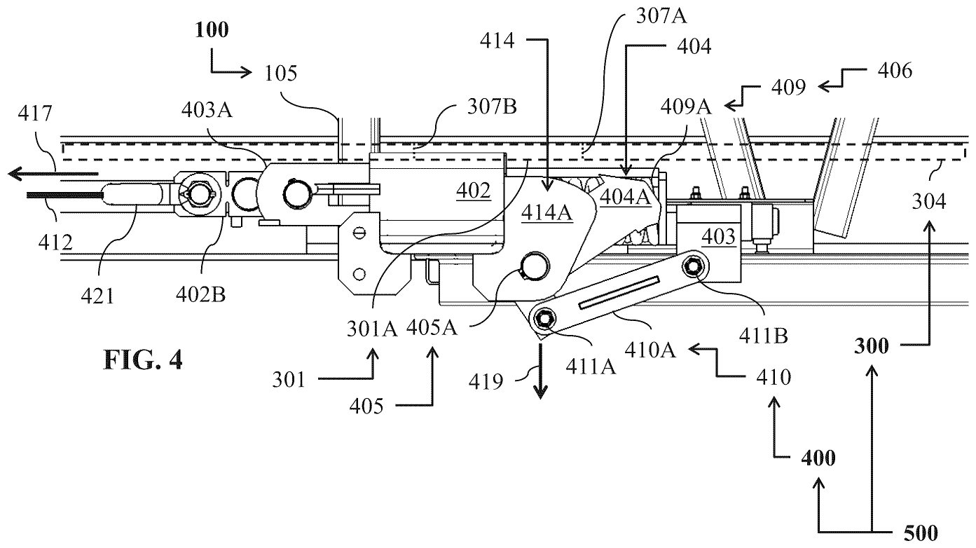

FIG. 4 depicts a side view of another embodiment of the brake assembly of any one of FIG. 1A and/or FIG. 1B; and

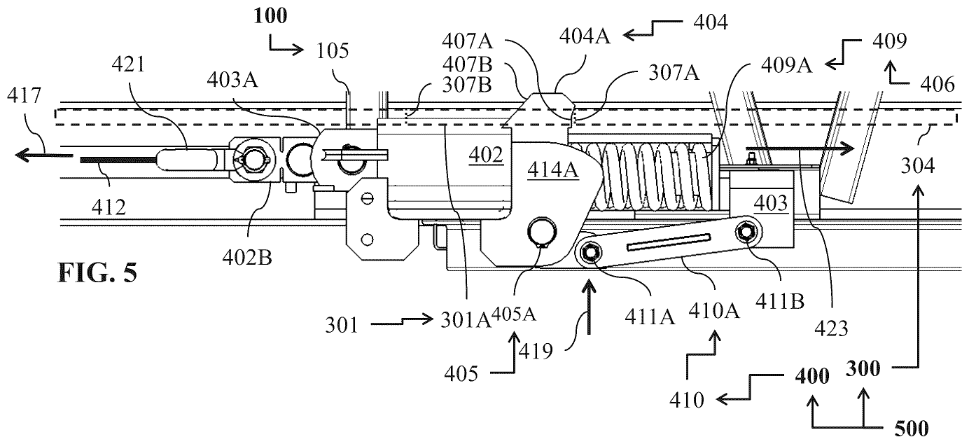

FIG. 5 depicts a side view of another embodiment of the brake assembly of any one of FIG. 1A and/or FIG. 1B; and

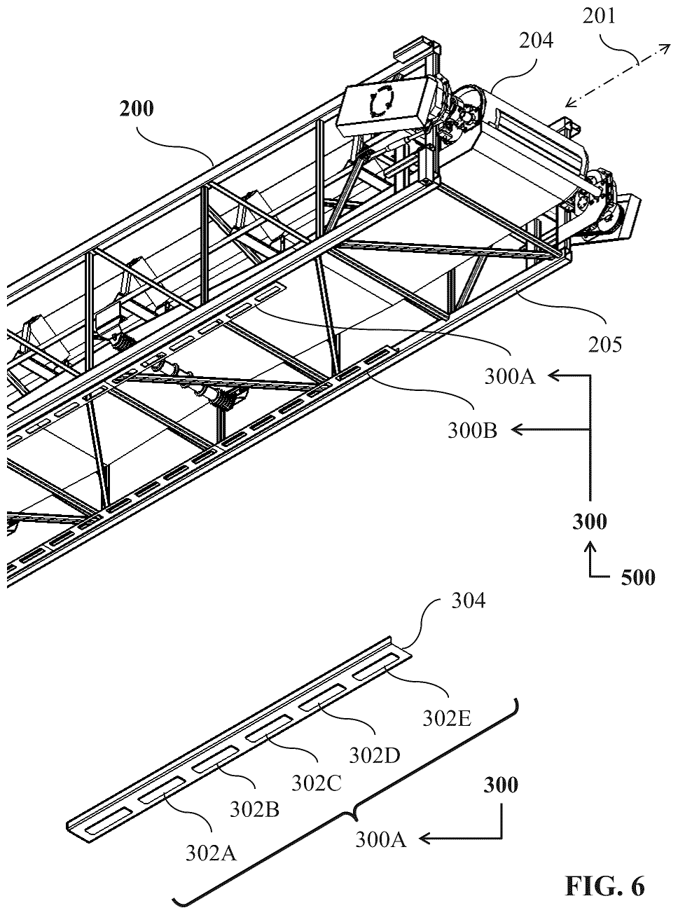

FIG. 6 depicts a close-up perspective view of another embodiment of the brake assembly of any one of FIG. 1A and/or FIG. 1B; and

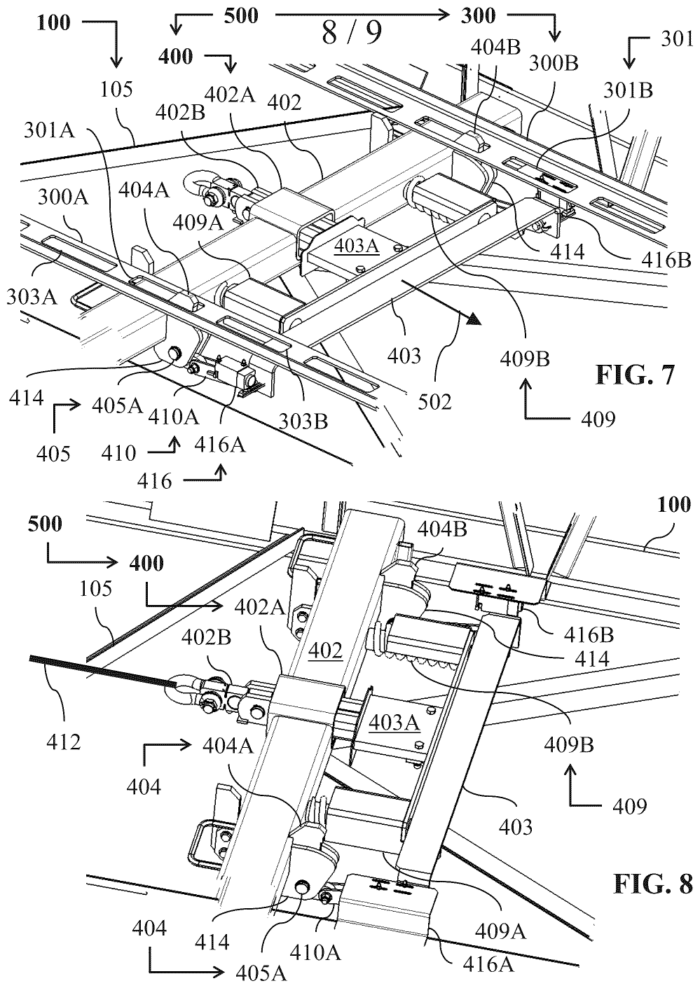

FIG. 7 and FIG. 8 depict perspective views of embodiments of the brake assembly of any one of FIG. 1A and/or FIG. 1B; and

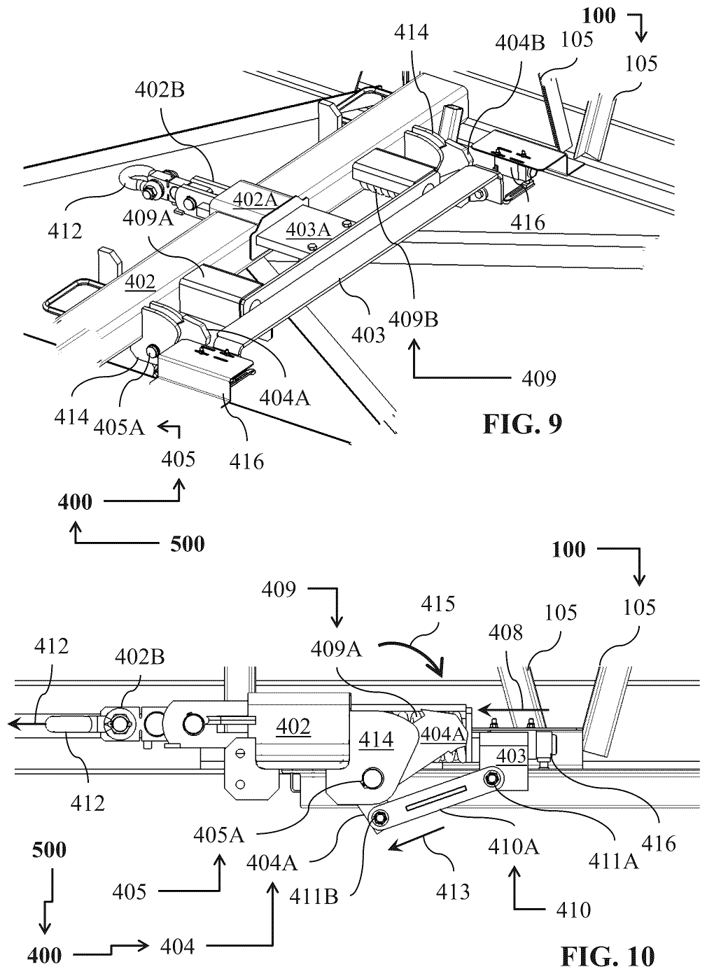

FIG. 9 and FIG. 10 depict a perspective view (FIG. 9) and a side view (FIG. 10) of embodiments of the brake assembly of any one of FIG. 1A and/or FIG. 1B.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, and well-understood, elements that are useful in commercially feasible embodiments are often not depicted to provide a less obstructed view of the embodiments of the present disclosure.

### LISTING OF REFERENCE NUMERALS USED IN THE DRAWINGS

first elongated assembly 100
elongated longitudinal axis 101
elongated length 103
first material-moving conveyor 104
first structural members 105
roller elements 106
take-up member 108
second connection point 111
first connection point 112
head section truss member 131
tail section truss member 132
head-end section 133
tail-end section 134
turnbuckle assembly 160
tension spring 161
first target plate 162A
second target plate 162B
tension limit switch 163
switch support member 164
load cell 170
safety drop pin 172
safety pin limit switch 174
first support wheels 190
second support wheels 192
elevation actuator assembly 194
base assembly 196
pivotal movement direction 198
working surface 199
second elongated assembly 200
elongated movement axis 201
second material-moving conveyor 204
second structural members 205
first cable 221
second cable 222
tail section truss 241
head section truss 242
tail-end section 243
head-end section 244
winch assembly 250
winch drum 252
spaced-apart engagement features 300
selectable engagement feature 301
grooves (302A, 302B, 302C, 302D, 302E)
elongated member 304
first spaced-apart engagement features 300A
second spaced-apart engagement features 300B
first selectable engagement feature 301A
second selectable engagement feature 301B
first neighboring engagement feature 303A
second neighboring engagement feature 303B
first inner edge portion 307A
second inner edge portion 307B
complementary engagement feature 400
first frame assembly 402
slide coupler 402A
tension connector 402B
second frame assembly 403
slide member 403A
shaped member 404
first shaped member 404A
second shaped member 404B
pivot member 405
first pivot member 405A
actuator assembly 406
first outer edge portion 407A
second outer edge portion 407B
spring-operation direction 408
spring assembly 409
first spring assembly 409A
second spring assembly 409B
linkage assembly 410
first linkage assembly 410A
first link connection 411A
second link connection 411B
tension line 412
link movement direction 413
spaced-apart guide plates 414
first spaced-apart guide plates 414A
second spaced-apart guide plates 414B
movement direction 415
limit switch 416
first limit switch 416A
second limit switch 416B
movement force 417
movement direction 418
movement direction 419
lug 421
retraction direction 423
brake assembly 500
arrow 502

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the disclosure is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments or any equivalent thereof) are described regarding the drawings. It should be understood that the disclosure is limited to the subject matter provided by the claims, and that the disclosure is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

FIG. 1A and FIG. 1B depict side views of embodiments of a brake assembly 500 for use with, or installable to, embodiments of first and second elongated assemblies (100, 200).

FIG. 1C, FIG. 1D, FIG. 1E and FIG. 1F depict top views (FIG. 1C and FIG. 1F) and side views (FIG. 1D and FIG. 1E) of embodiments of the first and second elongated assemblies (100, 200) of FIG. 1A.

Referring to the embodiments as depicted in FIG. 1A, FIG. 1B and FIG. 1C, there is depicted a winch assembly 250. In accordance with a preferred embodiment of the invention (also called an example of inventive design), there is provided or incorporated a brake assembly 500 (as depicted in FIG. 1B), which may be called a braking system and/or any equivalent thereof. It will be appreciated that an elevation actuator assembly 194 is configured to move the first elongated assembly 100 to a new position indicated as the first elongated assembly 100′ with the first structural members 105′.

Referring to the embodiment as depicted in FIG. 1B, the second elongated assembly 200 is removable (at least in part) from or is insertable (at least in part) into or with the first elongated assembly 100.

Returning to the embodiments as depicted in FIG. 1C and FIG. 1D, the brake assembly 500 is located or positioned at a second connection point 111 (which is also called the head-end wire rope termination or may be called connection number one, as depicted in FIG. 1D). The winch assembly 250 (also called a winch system) includes (and is not limited to) a winch drum 252 and/or any equivalent thereof. The winch drum 252 may be called an electric motor-driven drum, etc. The winch drum 252 is situated at the tail end of the second elongated assembly 200, which may include a telescoping inner conveyor assembly, etc. It will be appreciated that the synergistic combination of the second elongated assembly 200 and the first elongated assembly 100 may be referred to as a telescopic line of equipment or any equivalent thereof. The winch assembly 250 (also called a winch system and/or any equivalent thereof) includes (and is not limited to) a winch drum 252. The winch drum 252 is configured to selectively reel-in (take-in) or selectively reel-out (take-out) a first cable 221 and a second cable 222 (also called wire cables and/or any equivalent thereof). It will be appreciated that the term “selectively” is defined as a way that involves the selection of only a particular and specific thing, things, a condition or conditions. It will be appreciated that the term “securely” is defined as in a fixed or stable manner. Upon the winch drum 252, the first cable 221 and the second cable 222 are supported for selective action control or rope management by the winch drum 252. The first cable 221 and the second cable 222 may be called two winch wire ropes and/or any equivalent thereof. The first cable 221 and the second cable 222 are configured to be selectively spooled by the winch drum 252. The first cable 221 and the second cable 222 are further configured to support (actuate) the telescoping travel of the second elongated assembly 200 relative to the first elongated assembly 100. This is done in such a way that the winch assembly 250, in cooperative action with the first cable 221 and the second cable 222 urges selective movement (translation) of the second elongated assembly 200 into, at least in part, or out from, at least in part, the first elongated assembly 100. It will be appreciated that the first elongated assembly 100 includes a first elongated material-moving conveyor (not depicted but known to persons of skill in the art), in which the first elongated material-moving conveyor is configured to move materials along the elongated length of the first elongated assembly 100. It will be appreciated that the second elongated assembly 200 includes a second elongated material-moving conveyor (not depicted, but known to persons of skill in the art, such as a second material-moving conveyor 204 as depicted in FIG. 6), in which the second elongated material-moving conveyor is configured to move materials along the elongated length of the second elongated assembly 200. It will be appreciated that (A) the first elongated material-moving conveyor of the first elongated assembly 100 moves material toward the second elongated material-moving conveyor of the second elongated assembly 200, (B) the material is transferred from the first elongated material-moving conveyor to the second elongated material-moving conveyor, and (C) the second elongated material-moving conveyor of the second elongated assembly 200 moves the material along a length of the second elongated assembly 200. In this manner of operation, material may be moved from a first location to a second location, which may be changed as required or needed.

Referring to the embodiment as depicted in FIG. 1C, the first cable 221 (that is, one rope) goes to the head-end section 133. The head-end section 133 is also called the tail end of the machine also called the feed point, and any equivalent thereof. The second cable 222 (the other rope) goes up to the tail-end section 134 (also called the head end or discharge end). It will be appreciated that the entire load from the weight of the second elongated assembly 200 (also called and not limited to the inner conveyor) is on the first cable 221 (also called the latter cable and may also be referred to as the extending cable and/or any equivalent thereof).

Referring to the embodiments of the invention as depicted in FIG. 1A and FIG. 1B, there is depicted and provided a brake assembly 500. The brake assembly 500 may provide a more reliable stopping mechanism. In accordance with a preferred embodiment, the brake assembly 500 includes, and is not limited to, a synergistic combination of spaced-apart engagement features 300 and a complementary engagement feature 400. The winch assembly 250 is affixed to the second elongated assembly 200. The first cable 221 (of the winch assembly 250) is affixed to one end section of the first elongated assembly 100. The second cable 222 (of the winch assembly 250) is affixed to the complementary engagement feature 400 of the brake assembly 500. The complementary engagement feature 400 is configured to be fixedly mounted or securely affixed to a lower-end section of the first elongated assembly 100. The spaced-apart engagement features 300 are configured to be fixedly mounted or securely affixed to an elongated length of a lower section of the second elongated assembly 200. The secured mounting of the complementary engagement feature 400 and the spaced-apart engagement features 300 is done in such a way that the complementary engagement feature 400 is positioned proximate or intimately adjacent to a portion or a section of the spaced-apart engagement features 300. The complementary engagement feature 400 is configured to securely and selectively engage with a selectable portion of the spaced-apart engagement features 300.

Referring to the embodiments as depicted in FIG. 1A and FIG. 1B, the complementary engagement feature 400, in use, securely selectively engages with a selectable portion of the spaced-apart engagement features 300 in response to a predetermined machine state or a condition. The predetermined machine state may include and is not limited to the second cable 222 breaking or the tension in the second cable 222 becoming reduced or overly slack, or any equivalent thereof. By way of example, an equivalent alternative arrangement includes the installation of a sensor (and any equivalent), such as an accelerometer (known and not depicted). For instance, the sensor may be (preferably) configured to be mounted to the second elongated assembly 200. The sensor is configured to detect undesired movement (such as acceleration) of the second elongated assembly 200, in which the sensor is configured to provide a sensor signal to a controller unit (known and not depicted) which is configured to control selective operation of the brake assembly 500. For the case where the longitudinal alignment of the first elongated assembly 100 becomes tilted (moved or caused to become moved into a sloping position) relative to the working surface 199 or the horizon (as depicted in FIG. 1B) during normal operation of the first and second elongated assemblies (100, 200), the second cable 222 bears and supports the weight of the second elongated assembly 200. For this case, should the second cable 222 inadvertently break or fail, the second elongated assembly 200 will undesirably slide or uncontrollably move along the first elongated assembly 100, in which case this condition may lead to undesired structural damage and/or unwanted injury to personnel (workers). For the case where the second cable 222 fails, breaks or becomes loose, the complementary engagement feature 400, in use, responds to securely selectively engage with a selectable portion of the spaced-apart engagement features 300 so that relative movement between the first and second elongated assemblies (100, 200) is halted, and even more advantageously preferably as quickly as possible.

Referring to the embodiments as depicted in FIG. 1B and FIG. 1A, the brake assembly 500 is configured to be installed to, and used with, the first elongated assembly 100 and the second elongated assembly 200. The first elongated assembly 100 and the second elongated assembly 200 may be called the conveyors, or telescopically-movable conveyors and/or any equivalent thereof. In accordance with a preferred embodiment, the brake assembly 500 provides, preferably, a competitive technical advantage, in terms of increased confidence, that there may be minimal damage to the first elongated assembly 100 and the second elongated assembly 200 and/or their conveyors in the event of an operational failure of any one or more of the winch assembly 250 and/or the first cable 221 and/or the second cable 222, and/or any other detectable important machine conditions or machine states. It will be appreciated that the winch assembly 250 in combination with the first cable 221 and the second cable 222 is configured to selectively control the linear movement of the second elongated assembly 200 (including the inner conveyor also called the second conveyor) relative to the first elongated assembly 100. The first elongated assembly 100 may have an outer conveyor also called a first conveyor. In this manner, the first and second conveyors may continue to cooperate to move materials to a desired delivery position or location as needed. Furthermore, in accordance with another preferred embodiment, the brake assembly 500 provides, preferably, another competitive technical advantage provides reduced operational downtime of the machine (which is the synergistic combination of the first elongated assembly 100 and the second elongated assembly 200 along with their respective conveyors). And yet furthermore, in accordance with yet another preferred embodiment, the brake assembly 500 provides, preferably, yet another competitive technical advantage in terms of reduced maintenance costs related to accessing, repairing and resetting the brake assembly 500 (also called the stopping mechanism and/or any equivalent thereof).

Referring to the embodiments as depicted in FIG. 1C and FIG. 1D, the winch assembly 250 (the winch system) is configured for use with the brake assembly 500 (a preferred embodiment of the present invention). The winch assembly 250 includes and is not limited to the winch drum 252, which may be called an electric motor-driven drum and/or any equivalent thereof. The winch assembly 250 and the winch drum 252 are preferably situated or positioned at the tail end of the second elongated assembly 200 (also called a telescoping inner conveyor assembly and/or any equivalent thereof) of a telescopic line of equipment. The winch assembly 250 (winch system) also includes the winch assembly 250 (also called a winch drum) upon which a first cable 221 and a second cable 222 (two winch wire ropes) are spooled and configured to support the relative movement (telescoping travel) of the second elongated assembly 200 (having the inner conveyor) relative to the first elongated assembly 100. The first cable 221 (one of the wire ropes or the first wire rope) goes to, and is attached to, the tail-end section 134 (also called the tail end) of the first elongated assembly 100 (of the machine); it will be appreciated that the tail end of the first elongated assembly 100 is also called the feed point and/or any equivalent thereof. The feed point (of the first elongated assembly 100) is the location where materials are placed on one end of the first conveyor which is supported by the first elongated assembly 100. The second cable 222 (the other wire rope or the second wire rope) goes up to, and fixedly attaches to, a head-end section 244 (also called the head end or the discharge end). The discharge end is the location where the materials depart from the inner conveyor (of the second elongated assembly 200) at the head-end section 244 (end section) of the second elongated assembly 200. In accordance with a preferred embodiment, all of the load from the weight of the second elongated assembly 200 (including the inner conveyor of the second elongated assembly 200) is on the second cable 222 (the second wire rope), which may be also called the latter cable or may be referred to as the extending cable.

Referring to the embodiments as depicted in FIG. 1A and FIG. 1B, in accordance with a preferred embodiment, the brake assembly 500 includes (and is not limited to) a unique triggering design or configuration and/or any equivalent thereof. The triggering configuration has (includes and is not limited to) a spring assembly 409 (also called a spring-activating mechanism and/or any equivalent thereof). In accordance with a preferred embodiment, the spring assembly 409 is configured to ensure a relatively faster and/or a relatively more reliable engagement (activation of the brake assembly 500).

Referring to the embodiments as depicted in FIG. 1A and FIG. 1B, in accordance with a preferred embodiment, the brake assembly 500 is configured to reduce, at least in part, the stopping distance from about four feet to about eight inches, which might be a preferred distance between the catching slots (such as the grooves (302A, 302B, 302C, 302D, 302E) of the spaced-apart engagement features 300 (as depicted in FIG. 6). The brake assembly 500 is configured to allow, at least in part, for negligible damage (preferably no damage) for the case where one (such as a selectable engagement feature 301) of the catching slots (such as and not limited to the grooves (302A, 302B, 302C, 302D, 302E)) of the spaced-apart engagement features 300 might be missed (or not effectively engaged by at least one portion of the brake assembly 500, such as a complementary engagement feature 400). For the case where after one of the catching slots does not become successfully securely engaged, with at least one portion of the brake assembly 500, the brake assembly 500 may then have the opportunity to successfully engage on or with the next available catching slot which is positioned proximate to the missed catching slot, etc. It will be appreciated that, for the case where (A) the distance between adjacent catching slots is about eight inches, and (B) the brake assembly 500 might not successfully engage with a desired catching slot (such as, a selectable engagement feature 301), about 16 inches of stopping distance might be achieved with, or in accordance with, one specific but non-limiting embodiment for the case where one of the catching slots does not successfully (or immediately) engage with a proximate engageable portion (such as a portion of the complementary engagement feature 400) of the brake assembly 500.

Referring to the embodiments as depicted in FIG. 1A and FIG. 1B, the brake assembly 500 is configured to include (and is not limited to) a resetting mechanism when the winch assembly 250 is engaged to extend (the second elongated assembly 200), thereby providing a faster return to operation, and/or a safer method to reset (the brake assembly 500) which preferably does not require human interaction (if possible). Along with a relatively shorter stopping distance, the brake assembly 500 also might permit a relatively easier reset of the conveyors and/or may allow the operator to return the conveyors to service in a relatively faster manner. It will be appreciated to the person skilled in the art that the spring components can be changed for heavier springs to increase the speed of engagement of the brake assembly 500.

Referring to the embodiments as depicted in FIG. 1A and FIG. 1B, it will be appreciated that a preferred aspect or embodiment generally relates to a brake assembly 500 (braking system) for installation to or use with elongated telescopic conveyors and/or any equivalent thereof, and/or elongated assemblies configured to support respective conveyors and/or any equivalent thereof. Another preferred aspect or embodiment generally relates to a brake assembly 500 (brake system) with a brake plate for an inner conveyor and/or any equivalent thereof. Yet another preferred aspect or embodiment generally relates to a brake assembly 500 configured to act as a redundant brake system for an extending/retracting means (such as the winch assembly 250) of an inner conveyor system and/or any equivalent thereof. While some preferred aspects or embodiments are generally related to telescoping conveyors, and/or any equivalent thereof, other preferred aspects or embodiments are generally related to any other system requiring telescoping movement between elongated assemblies and/or any equivalent thereof. Yet another aspect (embodiment) generally relates to telescopic conveyors (and/or any equivalent thereof). The embodiment includes and is not limited to (is configured to act as) a brake assembly 500, which may be called a redundant brake system. The brake assembly 500 is configured to cooperate with the extending and retracting means (such as the winch assembly 250) of the second elongated assembly 200 (also called an inner conveyor system) of the telescopic conveyor machine (which is the synergistic combination of the first and second elongated assemblies (100, 200), and/or any equivalent thereof. Yet another aspect or embodiment generally relates to a brake assembly 500 (braking system) for an extending and retracting means (and/or any equivalent thereof, such as the winch assembly 250) of an inner conveyor system (such as the second elongated assembly 200 and/or any equivalent thereof) as described herein. Yet another aspect generally relates to a brake assembly 500 (also called a braking system) configured for relatively easier re-setting of the brake assembly 500 (also called a brake system) after engagement of the brake assembly 500 is not engaged to halt relative movement of the second elongated assembly 200 relative to the first elongated assembly 100, preferably as described herein (but limited thereto).

Referring to the embodiments as depicted in FIG. 1A and FIG. 1B, a specific problem is as follows: should the extending/retracting means (such as the winch assembly 250) fail, a preferred embodiment of the invention is configured to stop the movement of the second elongated assembly 200 (having the inner conveyor) from going into an uncontrolled retraction movement which has a relatively high potential for catastrophic damage and/or adverse harm or injury to any persons and/or personnel who may be positioned in relatively close (intimate) proximity to the first and second elongated assemblies (100, 200), etc.

FIG. 2 and FIG. 3 depict perspective views of other embodiments of the brake assembly 500 of any one of FIG. 1A and/or FIG. 1B.

Referring to the embodiments as depicted in FIG. 2 and FIG. 3, the complementary engagement feature 400 includes a first frame assembly 402 and a second frame assembly 403. The first frame assembly 402 is affixed to the structural members of the first elongated assembly 100. The second frame assembly 403 is configured to slide or glide relative to the first frame assembly 402. It will be appreciated that the tension line 412 (as depicted in FIG. 2) is equivalent to the second cable 222 of FIG. 1D. The dead-end termination is located or positioned on a sliding weldment; that is, the tension line 412 is securely, preferably, affixed (is configured to be securely affixed) to the second frame assembly 403. The sliding weldment, which is the synergistic combination of the first frame assembly 402 and the second frame assembly 403, is supported on steel work (the structural members) situated on the first elongated assembly 100 (which may have a first conveyor or an outer conveyor). The sliding mechanism (also called the sliding weldment) is, preferably, spring loaded such that for the case where there is (A) a loss of tension (in the tension line 412 of FIG. 2 or the second cable 222 of FIG. 1D), or (B) a sudden breakage of the extending winch cable (also called the tension line 412 of FIG. 2 or the second cable 222 of FIG. 1D), then the springs (such as the spring assembly 409) will biasedly expand to push the weldment (the second frame assembly 403) to slide forward relative to the first frame assembly 402 (in the direction of the arrow in FIG. 2). This action will, in turn, extend an engageable portion (such as the shaped member 404) of the complementary engagement feature 400. The shaped member 404 may be called a catching plate and/or any equivalent thereof. Preferably, there are two spaced-apart catching plates (such as the first shaped member 404A and the second shaped member 404B). The first shaped member 404A and the second shaped member 404B are connected to the second frame assembly 403 (also called the sliding frame) via, preferably, linkages, such as the linkage assembly 410.

Referring to FIG. 2, FIG. 3, FIG. 4 and FIG. 5, the linkage assembly 410 may include (A) a first linkage assembly 410A positioned on one side of the second frame assembly 403 and (B) a second linkage assembly (which is hidden and not depicted in these views) positioned on an opposite side of the second frame assembly 403.

FIG. 4 and FIG. 5 depict side views of embodiments of the brake assembly 500 of any one of FIG. 1A and FIG. 1B.

Referring to the embodiments as depicted in FIG. 4 and FIG. 5, there is depicted the linkage assembly 410 (also called a linkage) and the shaped member 404 (also called the extended catching plate). The brake assembly 500 (braking system) is configured for usage with the first and second elongated assemblies (100, 200), which in combination may be called a telescopic conveyor, and/or any equivalent thereof. In accordance with a preferred embodiment, the brake assembly 500 (the braking system) includes and is not limited to (comprises) the spaced-apart engagement features 300 (also called a mechanism) situated (mountable and secured) at the tail end section of the second elongated assembly 200 (also called the inner conveyor). The spaced-apart engagement features 300 is configured for usage with the winch assembly 250 (also called a wire rope winch system) configured to be used or implemented as the extending/retracting means configured to selectively move the second elongated assembly 200 relative to the first elongated assembly 100. The brake assembly 500 further includes a spring assembly 409 (also called a triggering mechanism) configured to react to a change of the amount of tension in (on) the tension line 412 (or the second cable 222 as depicted in FIG. 1A). The tension line 412 is also called a supporting winch cable. It will be appreciated that for the case of an under-tension and/or a broken cable scenario, the spring assembly 409 is configured to release the movement of a portion (such as the shaped member 404, or alternatively two drop pins, etc. of the complementary engagement feature 400). The shaped member 404 is configured to securely selectively engage (catch onto) at least one of the spaced-apart engagement features 300 that is mounted (at least in part, either directly or indirectly) to the second structural members 205 of the second elongated assembly 200. In this manner, the first structural members 105 of the first elongated assembly 100 (also called the main structure of the first conveyor or outer conveyer) may become securely latched with the second structural members 205 (the structure within which the second elongated assembly 200 having the inner conveyor) telescopes (or is movable relative thereto). The shaped member 404 may be called an extendable catching plate, and/or any equivalent thereof. The shaped member 404 (the catching plate) may be sized or dimensioned to be longer or thicker so that the shaped member 404 can accommodate heavier instances of elongated assemblies (such as inner conveyors).

FIG. 6 depicts a close-up perspective view of another embodiment of the brake assembly 500 of any one of FIG. 1A and FIG. 1B.

Referring to the embodiment as depicted in FIG. 6, the second elongated assembly 200 (having the inner conveyor) is the telescoping or moving portion of the machine) includes the first spaced-apart engagement features 300A and second spaced-apart engagement features 300B (also called a series of plates, etc.). The second spaced-apart engagement features 300B are spaced apart from the first spaced-apart engagement features 300A. The first spaced-apart engagement features 300A and the second spaced-apart engagement features 300B are each fixedly mounted (configured to be fixedly mounted) to the underside of the second elongated assembly 200. The first and second spaced-apart engagement features (300A, 300B) are preferably welded along the elongated length of the second elongated assembly 200 (the inner truss). The first and second spaced-apart engagement features (300A, 300B) may each define or are with slotted holes, preferably about eight to ten inches in length but other lengths are possible. The first and second spaced-apart engagement features (300A, 300B) (the slotted receiving plates) may have varying slot sizes and/or slot spacings to design or accommodate for different stopping distances, as might be required or desired. Referring to the embodiment as depicted in FIG. 6, it will be appreciated that other options for the extending and retracting means (that is, other than the winch assembly 250) may include (and is not limited to) a hydraulic cylinder instead of a wire rope system, whereby loss in hydraulic pressure may cause the loss in tension that may trigger the brake assembly 500. This alternative arrangement may be applicable to various versions of a hydraulic cylinder such as multistage cylinders or a series of single-stage cylinders, etc. It will be appreciated that other potential extending/retracting means may include a different variation on the wire rope system with the brake system switched to be positioned on the inner conveyor and cable coming up to a pulley and/or a sheave positioned on the first conveyor or the outer conveyor and back down. The end pulley system can be attached to the brake assembly 500 (brake system) and may provide another option. This system could also be used with a hydraulic cylinder and/or a chain drive system similar to what is used on a forklift apparatus.

FIG. 7 and FIG. 8 depict perspective views of embodiments of the brake assembly 500 of any one of FIG. 1A and FIG. 1B.

Referring to the embodiment as depicted in FIG. 7, once the portion (such as the shaped member 404, also called a catching plate) of the complementary engagement feature 400 is extended (and engaged with at least one portion or aspect of the spaced-apart engagement features 300), the shaped member 404 (such as the first shaped member 404A and the second shaped member 404B) securely engages into (or with) at least one of the aspects or portions of the spaced-apart engagement features 300 (such as the selectable engagement feature 301 or the slot) in order to stop the second elongated assembly 200 (the inner conveyor) from crashing with the first elongated assembly 100. As an example of the operation, the second cable 222 (as depicted in FIG. 1D or FIG. 1A, and which may be also called a winch cable) is attached to the brake assembly 500 (also called the braking system) at the second connection point 111 (as depicted in FIG. 1D). The second cable 222 is configured to pull on the second frame assembly 403 (also called the main brake weldment), which in turn compresses the spring assembly 409 (the springs and/or any equivalent thereof).

Referring to the embodiment as depicted in FIG. 7, for the case where there is a failure associated with the tension line 412 (or the second cable 222 of the winch assembly 250 as depicted in FIG. 1A, and may be called a winch cable), the spring assembly 409 (the springs or the first spring assembly 409A and the second spring assembly 409B) is configured to immediately force the second frame assembly 403 (the main brake weldment) to move (forwardly) in the direction of the arrow 502. This spring action will cause at least one portion (such as the catching plates) of the complementary engagement feature 400 to rotate upwardly (reference is made to FIG. 4 and FIG. 5) and engage with at least one aspect or portion (such as the slotted holes) of the spaced-apart engagement features 300 (also called plates) securely mounted to or on the underside of the second material-moving conveyor 204 (also called the inner conveyor, which is depicted in FIG. 6). At least one portion (such as the catching plates) of the complementary engagement feature 400 is operatively positioned or mounted (pivotally mounted) on each side (the opposite lateral sides) of the second frame assembly 403. The second frame assembly 403 is configured to be linearly movable and may be called a main brake weldment and/or any equivalent thereof.

Referring to the embodiment as depicted in FIG. 7, and in accordance with an embodiment, once the second frame assembly 403 (also called the sliding mechanism) is moved (extended), the second frame assembly 403 will move to trigger at least one limit switch, such as at least a limit switch 416 (such as at least one of a first limit switch 416A and/or a second limit switch 416B). Any one of the first limit switch 416A and the second limit switch 416B are configured to provide a signal indication to a PLC (programmable logic controller) which is known and not depicted. The PLC is programmed to respond to the signal indication in such a way that the PLC is urged to stop all controlled operation (movement) of the winch assembly 250 (the winch system). The PLC may provide a warning indication or an annunciation signal (visual or audible) to the operators so that they can respond accordingly.

Referring to the embodiment (of the innovation) as depicted in FIG. 7, the brake assembly 500 preferably includes (and is not limited to) the complementary engagement feature 400 having at least one of the shaped member 404. The complementary engagement feature 400 is operatively mounted and supported by the first elongated assembly 100. In a preferred embodiment, the shaped member 404 includes (and is not limited to) the first shaped member 404A (positioned at a first lateral side of the first elongated assembly 100) and the second shaped member 404B (positioned at a second lateral side of the first elongated assembly 100). The first shaped member 404A and the second shaped member 404B are spaced apart from each other.

The first shaped member 404A is configured to interact with at one aspect or feature of the first spaced-apart engagement features 300A (which is fixedly mounted to the second elongated assembly 200). The second shaped member 404B is configured to interact with at one aspect or feature of the second spaced-apart engagement features 300B (which is fixedly mounted to the second elongated assembly 200).

Referring to the embodiment (of the innovation) as depicted in FIG. 7, it will be appreciated that the shaped member 404 (which is a portion or aspect of the complementary engagement feature 400) may be called a brake plate and any equivalent thereof. An aspect or portion of the complementary engagement feature 400 is configured to stop or halt the undesired movement of the second elongated assembly 200 (also called the inner conveyor), and this halting action is preferred to occur within, for example, about ten inches from the time the brake assembly 500 is selectively actuated (and this halting distance is not limited to this exemplary distance). For the case where the undesired travel distance (of the second elongated assembly 200) becomes greater than, for example, ten inches (or other predetermined undesired travel distance), the geometry or physical aspects of the portion of the complementary engagement feature 400 (such as the plate thickness, etc.) may be configured (designed) to tear slightly to thereby prevent undesired shock impact to at least one or more structural aspects of the first and second elongated assemblies (100, 200), which in combination may be called the entire structure. This desired arrangement of the complementary engagement feature 400 is preferably configured to reduce, and more preferably, to stop and/or prevent the second elongated assembly 200 (the inner conveyor) from experiencing at least some (preferably any) potential catastrophic failure that might result from an uncontrolled descent of the second elongated assembly 200 (along the first elongated assembly 100) toward the direction of a working surface as a result of a breakage in the tension line 412 and/or the second cable 222 of FIG. 1A, etc.

Referring to the embodiment as depicted in FIG. 7, the brake assembly 500 may also provide the following technical feature: the linkage assembly 410 (also called a spring release mechanism). The linkage assembly 410 is configured to operate (in a substantial manner) or run in a parallel direction relative to the longitudinal length of the second elongated assembly 200 (the inner conveyor) versus operating in a perpendicular direction relative to the longitudinal length of the second elongated assembly 200.

Referring to the embodiment as depicted in FIG. 7, the brake assembly 500 (the innovation) preferably also provides the following technical feature: the ability to reset itself preferably without the usage of tooling and/or major tools (if possible). For the case where the winch assembly 250 (the winch) is engaged to extend, the second elongated assembly 200 from within the first elongated assembly 100, the second elongated assembly 200 (the inner conveyor) will translate (move) forwardly to release the contact (secured engagement) between (A) a portion or aspect (such as the catching plate) of the complementary engagement feature 400 and (B) a portion (such as the slotted plate, or the selectable engagement feature 301) of the spaced-apart engagement features 300. In turn, the tension exerted onto the second frame assembly 403 (the sliding mechanism) received from the tension line 412 or any equivalent thereof (also called the extend cable) will start to retract the portion or aspect (such as the shaped member 404, which is also called the catching plates) of the complementary engagement feature 400 along a downwardly direction, and thus reset (the whole system) to thereby permit relative movement between the second elongated assembly 200 and the first elongated assembly 100. In this manner, the selectable engagement feature 301 (of the spaced-apart engagement features 300) becomes entirely disengaged from a portion or aspect of the complementary engagement feature 400. For the case where the selectable engagement feature 301 (of the spaced-apart engagement features 300) becomes securely engaged with a portion or aspect of the complementary engagement feature 400 (that is the brake assembly 500 engages to stop relative movement of the first and second elongated assemblies 100, 200)), the operator may first determine the root cause or conditions (machine state) for this secured engagement (the selected activation of the brake assembly 500) to have happened. A first condition for activation of the brake assembly 500 might be the result of a broken winch cable (such as the tension line 412 and/or the second cable 222 of FIG. 1A, etc.). A second condition for activation of the brake assembly 500 might be the result of a jam that might have occurred during the retraction movement of the second elongated assembly 200 (having the inner conveyor) which might or would cause a slackening of the first cable 221 (which is depicted in FIG. 1A, and may also called the front winch cable); this condition in turn may or will cause the brake assembly 500 (the brakes) to securely engage to halt relative movement of the second elongated assembly 200 (relative to the first elongated assembly 100). After or once the broken cable (such as the tension line 412, the first cable 221 of FIG. 1A and/or the second cable 222 of FIG. 1A) is replaced, or the jam is removed (thereby releasing relative movement of the second elongated assembly 200). To reset the brake assembly 500 (the brake) may simply require the operator to extend or move the second elongated assembly 200 (extend the machine). Once the winch drum 252 of the winch assembly 250 starts rolling forward, any slack in the wire rope (such as the first cable 221 and/or the second cable 222 depicted in FIG. 1A, and/or the tension line 412) will be taken up followed by pulling back of the second frame assembly 403 (also called the main brake weldment) of the complementary engagement feature 400 (reference is made to FIG. 8).

FIG. 9 and FIG. 10 depict a perspective view (FIG. 9) and a side view (FIG. 10) of embodiments of the brake assembly 500 of any one of FIG. 1A and FIG. 1B.

Referring to FIG. 9 and FIG. 10, retracting (pulling back) of the second frame assembly 403 of the complementary engagement feature 400 may in turn cause resets, such as a first reset (A), a second reset (B), a third reset (C) and/or a fourth reset (D). For the first reset (A), the spring assembly 409 (the springs), which is configured to allow for the reaction speed for engagement of the brake assembly 500, will be compressed (as depicted in FIG. 9). For second reset (B), the limit switch (such as the first limit switch 416A and/or the second limit switch 416B) is configured to detect selective engagement (brake engagement) of the brake assembly 500, and and reset the brake assembly 500 thus allowing the PLC (programmable Logic Controller) to provide a signal indicating normal operation has resumed (as depicted in FIG. 9). For the third reset (C), the second elongated assembly 200 (the inner conveyor) will start to move forward which will release the brake assembly 500 from preventing relative movement of the second elongated assembly 200 in response to the selective engagement between (A) a portion or aspect (such as the shaped member 404 that is also called the catching plate) of the complementary engagement feature 400, and (B) a portion (such as, the slotted plate or the selectable engagement feature 301) of the spaced-apart engagement features 300. For the fourth reset (D), the linkage assembly 410 (the linkage) will allow a portion or aspect (such as the shaped member 404, also called the catching plate) of the complementary engagement feature 400 to be pulled down clear of the aspects or features (such, as the slotted track as depicted in FIG. 6) of the spaced-apart engagement features 300. The spaced-apart engagement features 300 are mounted to (on) the second elongated assembly 200 (which supports the inner conveyor also called the second material-moving conveyor 204, as depicted in FIG. 6 and FIG. 10).

Referring to the embodiments as depicted in FIG. 1A, FIG. 1B, FIG. 1C, FIG. 1D, FIG. 1E and FIG. 1F, there is depicted an apparatus. The apparatus includes and is not limited to a synergistic combination of a first elongated assembly 100, a second elongated assembly 200 and a brake assembly 500. It will be appreciated in accordance with a preferred embodiment, the brake assembly 500 may be provided separately from the first and second elongated assemblies (100, 200), for the retrofit installation of the brake assembly 500 to the first and second elongated assemblies (100, 200). The first elongated assembly 100 and the second elongated assembly 200 may include at least one or more conveyor assemblies (not depicted but known to persons skilled in the art) respectively installed or supported thereon. The conveyor assemblies are configured to move or convey materials from one location to another location. According to a preferred embodiment, the first elongated assembly 100 is stationary relative to the second elongated assembly 200. The second elongated assembly 200 is movable, at least in part, along an elongated movement axis 201 relative to the first elongated assembly 100. The elongated movement axis 201 may be called a linear movement axis. It will be appreciated that there may be, from time to time, relative movement between the second elongated assembly 200 and the first elongated assembly 100 to accommodate the positioning and/or operation of the conveyor systems and/or the first and second elongated assemblies (100, 200) in a desired and/or safe manner. Moreover, it will be appreciated that there may be a preferred requirement, which may occur from time to time, to halt relative movement between the first and second elongated assemblies (100, 200) in response to the detected occurrence of at least one or more certain predetermined undesired conditions which may present themselves, in which these undesired conditions may negatively or adversely impact to or one the desired positioning and/or operation of the first and second material-moving conveyors (104, 204) and/or the first and second elongated assemblies (100, 200). It is highly desired that the first and second material-moving conveyors (104, 204) and/or the first and second elongated assemblies (100, 200) operate in a desired safe manner so that costs and/or injury to personnel are reduced (at least in part) and/or preferably eliminated if possible. It will be appreciated that the brake assembly 500 provides a technical solution to the technical problem of halting relative movement between the first and second elongated assemblies (100, 200). Preferably, the brake assembly 500 is adapted or configured to operate in response to the detected occurrence of at least one or more certain predetermined undesired conditions which present themselves, in which these undesired conditions might negatively or adversely impact the desired positioning and/or operation of the conveyor systems and/or the first and second elongated assemblies (100, 200). Preferably, the brake assembly 500 provides a technical advantage for operating the conveyor systems and/or the first and second elongated assemblies (100, 200) in a desired safe manner so that costs and/or injury to personnel are reduced (at least in part) and/or preferably eliminated if possible. It will be appreciated that the second elongated assembly 200 is movable to a new position indicated as the second elongated assembly 200′ with the second structural members 205′.

Referring to the embodiment as depicted in FIG. 1F, there is depicted the first elongated assembly 100 and the second elongated assembly 200. The first elongated assembly 100 is configured to support (or includes) a first material-moving conveyor 104 configured to extend along, at least in part, the elongated length of the first elongated assembly 100. The second elongated assembly 200 is configured to support (or includes) a second material-moving conveyor 204 configured to extend, at least in part, along the elongated length of the second elongated assembly 200. The output section of the first material-moving conveyor 104 is configured to output or place material to the input section of the second material-moving conveyor 204. This is done in such a way that the material placed in the input section of the first material-moving conveyor 104 may be moved to the output section of the second material-moving conveyor 204.

Referring to the embodiments as depicted in FIG. 1A and/or FIG. 1B, the apparatus is further adapted such that the brake assembly 500 includes and is not limited to a synergistic combination of spaced-apart engagement features 300 and a complementary engagement feature 400 configured, in cooperative combination, to selectively securely engage the first elongated assembly 100 and the second elongated assembly 200 together. The brake assembly 500 may be called “means for selectable engagement” or any equivalent thereof. A technical effect of the brake assembly 500 is to thereby halt, at least in part, relative movement between the first elongated assembly 100 and the second elongated assembly 200. In this arrangement or operational manner, there may be a reduction of the possibility for inadvertent damage to equipment and/or injury to personnel, preferably in response to a detection of an unwanted or undesired condition, signal and/or operational state of the first and second elongated assemblies (100, 200). It will be appreciated that the term “selectively securely engage” may include “selectively securely latch” and may be accomplished in either a direct and/or an indirect arrangement and/or manner of operation. Preferably, the brake assembly 500 includes brake features or any equivalent thereof. For instance, a preferred embodiment of the brake features includes engagement features, such as spaced-apart grooves (302A, 302B, 302C, 302D, 302E) as depicted in FIG. 6 or any equivalent thereof. The brake features are serially positionable, one after another, in a spaced-apart close intimate arrangement or a spaced-apart close intimate relationship. Preferably, the brake features of the brake assembly 500 are also coaxially alignable, at least in part, along the elongated movement axis 201.

Referring to the embodiments as depicted in FIG. 1A and/or FIG. 1B, it will be appreciated that in accordance with a preferred embodiment, the brake assembly 500 (which is to be supplied by a first supplier) includes and is not limited to the spaced-apart engagement features 300 without the complementary engagement feature 400 (which is to be supplied by a second supplier not related to the first supplier), in which case the complementary engagement feature 400 may be retrofitted to the brake assembly 500 at a later time when the brake assembly 500 is physically installed to either one of the first and second elongated assemblies (100, 200).

Referring to the embodiments as depicted in FIG. 1A and/or FIG. 1B, it will be appreciated that in accordance with yet another preferred embodiment, the brake assembly 500 (which is to be supplied by a first supplier) includes and is not limited to the complementary engagement feature 400 (which may be supplied by a second supplier that is not related to the first supplier), and for this case the spaced-apart engagement features 300 may be retrofitted to the brake assembly 500 at a later time when the brake assembly 500 is physically installed to either one of the first and second elongated assemblies (100, 200).

Referring to the embodiments as depicted in FIG. 1B, the first elongated assembly 100 is configured to be mounted to a working surface 199, such as the ground, a flat horizontal platform, etc. The second elongated assembly 200 is extendable from, or telescopically extendable from, the first elongated assembly 100. The brake assembly 500 includes and is not limited to a synergistic combination of the spaced-apart engagement features 300 and the complementary engagement feature 400. The spaced-apart engagement features 300 is preferably configured to be fixedly mounted to (securely supported by) the second elongated assembly 200. The complementary engagement feature 400 is preferably configured to be fixedly mounted to (securely supported by) the first elongated assembly 100. The combination of the spaced-apart engagement features 300 and the complementary engagement feature 400 is configured to cooperatively halt, at least in part, relative movement between the first elongated assembly 100 and the second elongated assembly 200.

Referring to the embodiments as depicted in FIG. 1A and/or FIG. 1B, FIG. 4 and FIG. 6, the apparatus includes and is not limited to a synergistic combination of the first elongated assembly 100, the second elongated assembly 200, and the spaced-apart engagement features 300. Preferably, the spaced-apart engagement features 300 include and is not limited to a selectable engagement feature 301.

Referring to the embodiment as depicted in FIG. 6, the spaced-apart engagement features 300 preferably have and are not limited to engagement features, such as spaced-apart grooves (302A, 302B, 302C, 302D, 302E) or any equivalent thereof. The spaced-apart engagement features 300, such as spaced-apart grooves (302A, 302B, 302C, 302D, 302E), are serially positionable (locatable), one after another, in a spaced-apart close intimate arrangement or relationship. The spaced-apart engagement features 300, such as spaced-apart grooves (302A, 302B, 302C, 302D, 302E), are preferably coaxially alignable, at least in part, along the elongated movement axis 201.

Referring to the embodiments as depicted in FIG. 4 and FIG. 7, the first elongated assembly 100 and the second elongated assembly 200 are configured to be selectively securely engageable (latchable, either directly or indirectly) together at the selectable engagement feature 301. This is done in such a way that relative movement between the second elongated assembly 200 and the first elongated assembly 100 is, at least in part, halted once (when) the first elongated assembly 100 and the second elongated assembly 200 become selectively securely engaged with each other.

Referring to the embodiments as depicted in FIG. 1A, FIG. 1B, FIG. 5 and FIG. 7, the apparatus further includes a complementary engagement feature 400 or any equivalent thereof. The complementary engagement feature 400 is configured to be selectively securely engageable (latchable) with the selectable engagement feature 301 of the spaced-apart engagement features 300. There is a technical effect that is achieved for selective cooperation between the complementary engagement feature 400 and the selectable engagement feature 301 of the spaced-apart engagement features 300. Relative movement between the second elongated assembly 200 and the first elongated assembly 100 is, at least in part, halted once (when) the complementary engagement feature 400 and the selectable engagement feature 301 become selectively securely engaged (latched) with each other. Once (after, use of) selective secure engagement is made between the complementary engagement feature 400 and the selectable engagement feature 301, relative movement between the second elongated assembly 200 and the first elongated assembly 100 is, at least in part, halted.

Referring to the embodiments as depicted in FIG. 1A and/or FIG. 1B, the spaced-apart engagement features 300 are fixedly mounted to the second elongated assembly 200. The complementary engagement feature 400 is fixedly mounted to the first elongated assembly 100. It will be appreciated that other equivalent arrangements may be contemplated.

Referring to the embodiments as depicted in FIG. 1A and/or FIG. 1B, the first elongated assembly 100 has first structural members 105 or any equivalent thereof. The first elongated assembly 100 also has an elongated longitudinal axis 101 extending along an elongated length 103 of the first elongated assembly 100. The second elongated assembly 200 has second structural members 205 or any equivalent thereof. The second elongated assembly 200 is also configured to be coaxially alignable relative to the elongated longitudinal axis 101 of the first elongated assembly 100. The first elongated assembly 100 is stationary relative to the working surface 199. The first elongated assembly 100 is, preferably, adapted to receive, cradle and support linear movement of the second elongated assembly 200 along the elongated longitudinal axis 101 of the first elongated assembly 100. The second elongated assembly 200 is configured to be movable along the elongated longitudinal axis 101 of the first elongated assembly 100. The second elongated assembly 200 is configured to selectively extend from, or selectively retract within, an end section of the first elongated assembly 100, preferably in response to the operation of the winch assembly 250.

Referring to the embodiments as depicted in FIG. 1A, FIG. 1B and FIG. 1E, the first elongated assembly 100 has the first structural members 105. The first elongated assembly 100 also has an elongated longitudinal axis 101 extending along an elongated length 103 of the first elongated assembly 100.

Referring to the embodiments as depicted in FIG. 1A and FIG. 1B, the apparatus is further adapted to include and is not limited to a complementary engagement feature 400 configured to be securely fixedly supportable to the first structural members 105 of the first elongated assembly 100.

Referring to the embodiments as depicted in FIG. 1A, FIG. 1B and FIG. 1F, the second elongated assembly 200 has second structural members 205. The second elongated assembly 200 is configured to be telescopically extendable and movable relative to the first elongated assembly 100 along an elongated movement axis 201. The elongated movement axis 201 is coaxially aligned relative to the elongated longitudinal axis 101 of the first elongated assembly 100.

Referring to the embodiment as depicted in FIG. 4 and FIG. 6, the spaced-apart engagement features 300 (as depicted in FIG. 6) include the selectable engagement feature 301 (as depicted in FIG. 4). As depicted in FIG. 6, the spaced-apart engagement features 300 have engagement features, such as spaced-apart grooves (302A, 302B, 302C, 302D, 302E). The spaced-apart engagement features 300 are configured to be coaxially alignable, at least in part, relative to the elongated movement axis 201.

Referring to the embodiment as depicted in FIG. 6, the spaced-apart engagement features 300, such as spaced-apart grooves (302A, 302B, 302C, 302D, 302E) are preferably configured to be serially positionable, one after another, in a spaced-apart close intimate arrangement (relationship) along (to) the second structural members 205 of the second elongated assembly 200. In accordance with a preferred embodiment, the spaced-apart engagement features 300 include first spaced-apart engagement features 300A configured to be mounted to a first lower elongated side of the second elongated assembly 200. The spaced-apart engagement features 300 also include second spaced-apart engagement features 300B configured to be mounted to a second lower elongated side of the second elongated assembly 200. The second lower elongated side of the second elongated assembly 200 is spaced apart from the first lower elongated side of the second elongated assembly 200.

Referring to the embodiment as depicted in FIG. 6, the spaced-apart engagement features 300 have spaced-apart grooves (302A, 302B, 302C, 302D, 302E). The spaced-apart grooves (302A, 302B, 302C, 302D, 302E) are configured to be serially linearly securely located and positioned, at least in part, in a spaced-apart close intimate arrangement (relationship) longitudinally along at least some of the second structural members 205 of the second elongated assembly 200 once (after) the spaced-apart engagement features 300, such as spaced-apart grooves (302A, 302B, 302C, 302D, 302E), are operatively mounted to (fixedly attached to) at least some of the second structural members 205.

Referring to the embodiment as depicted in FIG. 6, the spaced-apart grooves (302A, 302B, 302C, 302D, 302E) of the spaced-apart engagement features 300 are configured to be, at least in part, coaxially aligned relative to the elongated movement axis 201 (and/or the elongated longitudinal axis 101 of the first elongated assembly 100 as depicted in FIG. 1A and/or FIG. 1B).

Referring to the embodiment as depicted in FIG. 6, the spaced-apart engagement features 300 include or may be defined by (and are not limited to) an elongated member 304 or any equivalent thereof. The elongated member 304 is configured to be mounted (directly or indirectly) to, and along, an elongated length of the second elongated assembly 200. The elongated member 304 defines, at least in part, the spaced-apart grooves (302A, 302B, 302C, 302D, 302E) that are serially aligned along an elongated length of the elongated member 304.

Referring to the embodiment as depicted in FIG. 6, the spaced-apart engagement features 300 include (and are not limited to) an elongated member 304 and any equivalent thereof. The elongated member 304 is configured to be attached, at least in part, to the second structural members 205 of the second elongated assembly 200. The elongated member 304 defines spaced-apart grooves. For this embodiment, the spaced-apart grooves (302A, 302B, 302C, 302D, 302E) are defined by, or provided by, the elongated member 304.

Referring to the embodiments as depicted in FIG. 5 and FIG. 7, the first elongated assembly 100 and the second elongated assembly 200 are selectively securely engageable (latchable) together at a portion) of the selectable engagement feature 301 to thereby halt, at least in part, relative movement between the second elongated assembly 200 and the first elongated assembly 100. This halting arrangement (halting operation) is achieved in response to the first elongated assembly 100 and the second elongated assembly 200 becoming selectively securely engaged with each other at the selectable engagement feature 301 of the brake assembly 500.

Referring to the embodiments as depicted in FIG. 5 and FIG. 7, the complementary engagement feature 400 is selectively securely engageable (latchable) with the selectable engagement feature 301 to thereby halt, at least in part, relative movement between the second elongated assembly 200 and the first elongated assembly 100. This halting arrangement (halting action) is done once the complementary engagement feature 400 is selectively securely engaged (latched) with the selectable engagement feature 301 of the spaced-apart engagement features 300. It will be appreciated that one or more equipment conditions or states may be used to trigger this halting arrangement (halting action). The complementary engagement feature 400 is configured to apply a halting force (a breaking force) to the selectable engagement feature 301 of the spaced-apart engagement features 300, which may be performed or done in response to a detection of a predetermined condition or machine state, such as the closure of an emergency switch, etc.

Referring to the embodiments as depicted in FIG. 5 and FIG. 7, the complementary engagement feature 400 is configured to be selectively securely engageable (latchable) with the selectable engagement feature 301. This is done in such a way that secure engagement (directly or indirectly) between the complementary engagement feature 400 and the selectable engagement feature 301, in cooperative action, halts, at least in part, relative movement between the second elongated assembly 200 and the first elongated assembly 100.

Referring to the embodiments as depicted in FIG. 5 and FIG. 7, the complementary engagement feature 400 is configured to be coupled (directly or indirectly) to a tension line 412. A portion (such as the shaped member 404) of the complementary engagement feature 400 is also configured to biasedly securely engage with a portion (such as the first inner edge portion 307A) of the selectable engagement feature 301. This is done so that in response to an increase in tension of the tension line 412, relative movement between the first elongated assembly 100 and the second elongated assembly 200 may be, at least in part, halted (arrested).

Referring to the embodiments as depicted in FIG. 5 and FIG. 7, the complementary engagement feature 400 is configured to be coupled to the tension line 412. A portion (such as the shaped member 404) of the complementary engagement feature 400 is also configured to selectively securely engage with a portion (the first inner edge portion 307A) of the selectable engagement feature 301. This arrangement (action) is done in response to reduction (relaxation) in tension in the tension line 412. This action is done in such a way that the portion (such as the shaped member 404) of the complementary engagement feature 400 selectively engages with the portion (such as the first inner edge portion 307A) of the selectable engagement feature 301. In this manner or action, relative movement is halted (prevented), at least in part, between the second elongated assembly 200 and the first elongated assembly 100.

Referring to the embodiments as depicted in FIG. 4, FIG. 6 and FIG. 10, the complementary engagement feature 400 is selectively securely disengageable (delatchable) from the selectable engagement feature 301 to thereby permit relative movement between the second elongated assembly 200 and the first elongated assembly 100. This permitting arrangement (permitting action) is done once the complementary engagement feature 400 is selectively securely disengaged (delatched) from the selectable engagement feature 301 of the spaced-apart engagement features 300. It will be appreciated that one or more equipment conditions or states may be used to trigger this permitting arrangement (permitting action). The complementary engagement feature 400 is configured to be selectively disengageable from the selectable engagement feature 301 of the spaced-apart engagement features 300, in which the spaced-apart engagement features 300 are securely positioned to (fixedly mounted to) the first structural members 105 of the first elongated assembly 100 (as depicted in FIG. 6).

Referring to the embodiments as depicted in FIG. 4, FIG. 6 and FIG. 10, the complementary engagement feature 400 is configured to be coupled to a tension line 412. A portion (such as a shaped member 404) of the complementary engagement feature 400 is configured to biasedly disengage away from a portion (such as a first inner edge portion 307A) of the selectable engagement feature 301. This arrangement (action) is done in response to an increase of tension of (in) the tension line 412 so that the first elongated assembly 100 and the second elongated assembly 200 become movable (may move) relative to each other.

Referring to the embodiments as depicted in FIG. 4, FIG. 6 and FIG. 10, the complementary engagement feature 400 is configured to be coupled to the tension line 412. The portion (such as the shaped member 404) of the complementary engagement feature 400 is configured to selectively disengage, and move away, from any engagement with the portion (such as the first inner edge portion 307A) of the selectable engagement feature 301. The arrangement (action) is done in response to an increase in tension in the tension line 412. This is done in such a way that the portion (that is, the shaped member 404) of the complementary engagement feature 400 becomes placed (positioned) in a disengaged relationship from the portion (that is, the first inner edge portion 307A) of the selectable engagement feature 301 so that relative movement may be permitted between the second elongated assembly 200 and the first elongated assembly 100.

Referring to the embodiments as depicted in FIG. 4 and FIG. 5, the complementary engagement feature 400 is configured to be selectively engageable with, and selectively disengageable from, the selectable engagement feature 301 between (A) an intimate secured contact engagement (as depicted in FIG. 5), and (B) a non-contact engagement (as depicted in FIG. 4). In the intimate secured contact engagement (as depicted in FIG. 5), a portion (such as the shaped member 404) of the complementary engagement feature 400 engages (securely engages) with a portion (such as the first inner edge portion 307A) of the selectable engagement feature 301 to thereby halt (at least in part) relative movement between the first elongated assembly 100 and the second elongated assembly 200. In the non-contact engagement (as depicted in FIG. 4), the complementary engagement feature 400 remains unengaged with the selectable engagement feature 301 to thereby permit relative movement (free movement) between the first elongated assembly 100 and the second elongated assembly 200.

Referring to the embodiments as depicted in FIG. 4 and FIG. 5, the selectable engagement feature 301 (of the spaced-apart engagement features 300) is sized to be proximately larger than a portion (such as a shaped member 404) of the complementary engagement feature 400 to facilitate movement of a portion (the shaped member 404) of the complementary engagement feature 400 into the selectable engagement feature 301.

Referring to the embodiment as depicted in FIG. 7, the selectable engagement feature 301 of spaced-apart engagement features 300 is positioned in a relatively close proximate relationship to proximate neighboring engagement features, such as first and second neighboring engagement features (303A, 303B) such as neighboring grooves, in a linear relationship.

Referring to the embodiment as depicted in FIG. 7, the spaced-apart engagement features 300 are each configured to be in a selective close intimate contact relationship (engagement) with a portion (such as the shaped member 404) of the complementary engagement feature 400. This is done in response to the selective close intimate engagement to be made between a selected one of the spaced-apart engagement features 300 and the portion (such as the shaped member 404) of the complementary engagement feature 400.

Referring to the embodiment as depicted in FIG. 7, the complementary engagement feature 400 includes and is not limited to a first frame assembly 402 and a second frame assembly 403. The first frame assembly 402 is configured to be fixedly attached to the first elongated assembly 100. The second frame assembly 403 is configured to be movable relative to the first frame assembly 402.

Referring to the embodiments as depicted in FIG. 4 and FIG. 5, the complementary engagement feature 400 further includes a shaped member 404 or any equivalent thereof. The shaped member 404 preferably includes an L-shaped member. The shaped member 404 is configured to be operatively mounted (more preferably pivotally mounted) to the first frame assembly 402. The shaped member 404 is configured to be movable into the selectable engagement feature 301 (as depicted in FIG. 5). The shaped member 404 is also configured to be movable out from the selectable engagement feature 301 (as depicted in FIG. 4). In accordance with a preferred embodiment, the shaped member 404 includes first and second shaped members (404A, 404B) that are spaced-apart from each other. The first and second shaped members (404A, 404B) are configured to interact respectively with the first and second spaced-apart engagement features (300A, 300B) that are depicted in FIG. 6.

Referring to the embodiments as depicted in FIG. 4, FIG. 5, FIG. 7 and FIG. 8, the shaped member 404 is pivotally mounted (via a pivot member 405) to the first frame assembly 402. It will be appreciated that the first shaped member 404A is pivotally mounted (via a first pivot member 405A as depicted in FIG. 4 and FIG. 5) to a first lateral side of the first frame assembly 402 (which is depicted in FIG. 7 and FIG. 8). It will be appreciated that the second shaped member 404B (which is hidden in FIG. 4 and FIG. 5 but is depicted in FIG. 7 and FIG. 8) is configured to be pivotally mounted (via a second pivot member which is hidden in these view) to a second lateral side of the first frame assembly 402 (which is depicted in FIG. 7 and FIG. 8). The second lateral side of the first frame assembly 402 (which is depicted in FIG. 7 and FIG. 8) is spaced apart from the first lateral side of the first frame assembly 402 (which is depicted in FIG. 7 and FIG. 8).

Referring to the embodiments as depicted in FIG. 4 and FIG. 5, the complementary engagement feature 400 further includes and is not limited to an actuator assembly 406. The actuator assembly 406 is configured to actuate selective movement of the shaped member 404 into, and out from, the selectable engagement feature 301.

Referring to the embodiments as depicted in FIG. 4 and FIG. 5, the actuator assembly 406 includes and is not limited to a spring assembly 409. The spring assembly 409 is configured to be selectively compressed (in response to an increased application of tension to the spring assembly 409, as depicted in FIG. 4). The spring assembly 409 is also configured to decompress in response to the reduction of tension to the spring assembly 409. The spring assembly 409 is also configured to biasedly engage a portion (such as the shaped member 404) of the complementary engagement feature 400 with a portion (such as the first inner edge portion 307A) of the selectable engagement feature 301, as depicted in FIG. 5.

Referring to the embodiments as depicted in FIG. 4 and FIG. 5, the actuator assembly 406 further includes and is not limited to a tension line 412 configured to be coupled (either directly or indirectly) to the spring assembly 409. In response to increased tension in the tension line 412, the spring assembly 409 becomes compressed to thereby securely engage the complementary engagement feature 400 with the selectable engagement feature 301 (as depicted in FIG. 4). In response to decreased tension in the tension line 412, the spring assembly 409 becomes relaxed to thereby disengage the complementary engagement feature 400 with the selectable engagement feature 301 (as depicted in FIG. 5).

Referring to the embodiment as depicted in FIG. 4, the spring assembly 409 is configured to biasedly disengage the complementary engagement feature 400 away from the selectable engagement feature 301. This arrangement or action is done in response to a reduction in tension, at least in part, in or of the tension line 412. This action or arrangement is done in such a way that the spring assembly 409, in use, urges the complementary engagement feature 400 to move away from the selectable engagement feature 301 to thereby permit relative free movement between the first elongated assembly 100 and the second elongated assembly 200.

Referring to the embodiment as depicted in FIG. 5, the spring assembly 409 is also configured to securely biasedly engage the complementary engagement feature 400 with the selectable engagement feature 301. This is done in response to an increase in tension of the tension line 412 in such a way that the spring assembly 409 urges, in use, the complementary engagement feature 400 to securely engage the selectable engagement feature 301 to thereby halt, at least in part, relative movement between the first elongated assembly 100 and the second elongated assembly 200.

Referring to the embodiments as depicted in FIG. 4 and FIG. 5, the complementary engagement feature 400 includes a spring assembly 409. The spring assembly 409 is also configured to operate along a spring-operation direction 408 being coaxially aligned, at least in part, relative to the tension line 412 placed under tension.

Referring to the embodiments as depicted in FIG. 4, the complementary engagement feature 400 further includes and is not limited to a linkage assembly 410. The linkage assembly 410 is configured to link, either directly or indirectly, the complementary engagement feature 400 with the spring assembly 409. The linkage assembly 410 is configured to urge movement of the complementary engagement feature 400 away from the selectable engagement feature 301 in response to a reduction in tension of the tension line 412.

Referring to the embodiments as depicted in FIG. 5, the linkage assembly 410 is also configured to securely engage, in cooperation with a spring assembly 409, the complementary engagement feature 400 with the selectable engagement feature 301 in response to an application of tension to the tension line 412.

Referring to the embodiments as depicted in FIG. 4 and FIG. 5, a method is provided for operating the first elongated assembly 100 and the second elongated assembly 200, with spaced-apart engagement features 300 of a brake assembly 500. The spaced-apart engagement features 300 include and are not limited to a selectable engagement feature 301. The spaced-apart engagement features 300 also include and are not limited to the spaced-apart grooves (302A, 302B, 302C, 302D, 302E) that are serially positionable one after another in a spaced-apart close intimate arrangement (relationship). The spaced-apart grooves (302A, 302B, 302C, 302D, 302E) are coaxially alignable, at least in part, along the elongated movement axis 201 (which is depicted in FIG. 1A and/or FIG. 1B). Referring back to FIG. 4 and FIG. 5, the method includes and is not limited to the following technical step: selectively securely engaging (latching) together at the selectable engagement feature 301 of the brake assembly 500 to thereby halt, at least in part, relative movement between the second elongated assembly 200 and the first elongated assembly 100.

Referring to the embodiments as depicted in FIG. 1A, FIG. 1B, FIG. 4, FIG. 5 and FIG. 6, a method is provided. The method includes and is not limited to the following synergistic combination of technical steps or operations: (A) positioning the first elongated assembly 100 (referring to FIG. 1A and/or FIG. 1B) and (B) positioning the second elongated assembly 200 (referring to FIG. 1A and/or FIG. 1B) that is movable relative to the first elongated assembly 100 along the elongated movement axis 201. The method further includes (C) serially positioning the spaced-apart engagement features 300 of a brake assembly 500 including a selectable engagement feature 301, one after another, in a spaced-apart close intimate arrangement (relationship) so that the spaced-apart engagement features 300 are coaxially aligned, at least in part, along the elongated movement axis 201. The method further includes and is not limited to (D) selectively securely engaging (latching) together the first and second elongated assemblies (100, 200) at the selectable engagement feature 301 to thereby halt, at least in part, relative movement between the second elongated assembly 200 and the first elongated assembly 100 (referring to FIG. 4 and FIG. 5).

Referring to the embodiments as depicted in FIG. 1A, FIG. 1B, FIG. 4 and FIG. 5, an apparatus is configured to be usable with the first elongated assembly 100 and a second elongated assembly 200 that is movable, at least in part, along the elongated movement axis 201 (also known as a linear movement axis) relative to the first elongated assembly 100. The apparatus includes and is not limited to a brake assembly 500. The brake assembly 500 includes and is not limited to spaced-apart engagement features 300. The spaced-apart engagement features 300 include and are not limited to a selectable engagement feature 301. The spaced-apart engagement features 300 also include spaced-apart grooves (302A, 302B, 302C, 302D, 302E) that are serially positionable, one after another, in a spaced-apart close intimate arrangement (relationship). The spaced-apart engagement features 300, such as the spaced-apart grooves (302A, 302B, 302C, 302D, 302E) are also coaxially alignable, at least in part, along the elongated movement axis 201. The brake assembly 500 also includes a complementary engagement feature 400 configured to be selectively securely engageable (latchable) with the selectable engagement feature 301.

Referring to the embodiments as depicted in FIG. 1A, FIG. 1B, FIG. 4 and FIG. 5, the complementary engagement feature 400 is also configured to halt, at least in part, relative movement between the second elongated assembly 200 and the first elongated assembly 100 in response to selective secured engagement (latchment) between the complementary engagement feature 400 the selectable engagement feature 301.

Referring to the embodiments as depicted in FIG. 1A, FIG. 1B, FIG. 4 and FIG. 5, the first elongated assembly 100 and the second elongated assembly 200 become selectively securely engageable (latchable, either directly or indirectly) together at the selectable engagement feature 301 in response to the complementary engagement feature 400, in use, selectively securely engaging (latching) with the selectable engagement feature 301 to thereby halt, at least in part, relative movement between the second elongated assembly 200 and the first elongated assembly 100.

Referring to the embodiments as depicted in FIG. 1A, FIG. 1B, FIG. 4 and FIG. 5, the spaced-apart engagement features 300 are fixedly mounted to the second elongated assembly 200. The complementary engagement feature 400 is fixedly mounted to the first elongated assembly 100.

Referring to the embodiments as depicted in FIG. 1A, FIG. 1B, FIG. 4 and FIG. 5, an apparatus is usable with the first elongated assembly 100 and a second elongated assembly 200. The apparatus is also usable with the spaced-apart engagement features 300 including and not limited to a selectable engagement feature 301. The spaced-apart engagement features 300 also include (and is not limited to) spaced-apart grooves (302A, 302B, 302C, 302D, 302E) that are serially positionable, one after another, in a spaced-apart close intimate arrangement (relationship). The spaced-apart engagement features 300 are coaxially alignable, at least in part, along the elongated movement axis 201. The apparatus includes and is not limited to a brake assembly 500 including and not limited to a complementary engagement feature 400 configured to be selectively securely engageable (latchable) with the selectable engagement feature 301. The complementary engagement feature 400 is also configured to halt, at least in part, relative movement between the second elongated assembly 200 and the first elongated assembly 100 in response to selective secured engagement (latchment) between the complementary engagement feature 400 the selectable engagement feature 301.

Referring to the embodiments as depicted in FIG. 1A, FIG. 1B, FIG. 4 and FIG. 5, the first elongated assembly 100 and the second elongated assembly 200 become selectively securely engageable (latchable, either directly or indirectly) together at the selectable engagement feature 301 in response to the complementary engagement feature 400, in use, selectively securely engaging (latching) with the selectable engagement feature 301 to thereby halt, at least in part, relative movement between the second elongated assembly 200 and the first elongated assembly 100.

Referring to the embodiment as depicted in FIG. 1A, the first elongated assembly 100 includes (has) an elongated longitudinal axis 101 extending along the elongated length of the first elongated assembly 100. The second elongated assembly 200 is configured to be movable relative to the first elongated assembly 100. The second elongated assembly 200 is movable along the elongated movement axis 201. The elongated movement axis 201 and the elongated longitudinal axis 101 are parallel and/or coaxially alignable relative to each other. In accordance with a preferred embodiment, the first and second elongated assemblies (100, 200) include respective conveyor systems, such as first and second material-moving conveyors (104, 204). The first material-moving conveyor 104 of the first elongated assembly 100 is configured to move the material toward the second material-moving conveyor 204 of the second elongated assembly 200. The material is transferred from the first material-moving conveyor 104 to the second material-moving conveyor 204. The second elongated assembly 200 (having the second material-moving conveyor 204)) may be positioned and aligned so that the output of the second material-moving conveyor 204 may be deposited at a desired position or location, as needed.

Referring to the embodiment as depicted in FIG. 1B, the first elongated assembly 100 is operatively supported to the working surface 199. An elevation actuator assembly 194 is attached to a section of the first elongated assembly 100. The elevation actuator assembly 194 is configured to selectively move (lift or lower) a portion of the first elongated assembly 100 relative to the working surface 199. This is done, preferably, in such a way that (A) the input section of the first elongated assembly 100 remains proximate to the working surface 199, and (B) the output section of the first elongated assembly 100 is movable relative to (either closer to or further away from) the working surface 199. In accordance with a preferred embodiment, a portion or section of the first elongated assembly 100 is configured to be supported by the working surface 199.

Referring to the embodiment as depicted in FIG. 1C, the winch assembly 250 is mounted and affixed to the second elongated assembly 200. The winch drum 252 is configured to handle the first cable 221 and the second cable 222.

Referring to the embodiment as depicted in FIG. 1C, the winch assembly 250 (movement actuator) is configured to move the second elongated assembly 200 relative to the first elongated assembly 100. The winch assembly 250 is configured to be mounted to the second elongated assembly 200. The first cable 221 is configured to be attached to the head section truss member 131 of the first elongated assembly 100. The second connection point 111 is where the second cable 222 is attached to a portion or a section of the brake assembly 500, and the brake assembly 500 is supported, at least in part, by the first elongated assembly 100. It will be appreciated that (A) some components of the brake assembly 500 are configured to be selectively movable (relative to the first elongated assembly 100) and (B) other portions of the brake assembly 500 are configured to be relatively stationary (and securely mountable to the first elongated assembly 100). It is understood that the second cable 222 is fixedly attached to at least one portion of the brake assembly 500.

Referring to the embodiment as depicted in FIG. 1C, roller elements 106 (and/or any equivalent thereof) are configured to support relative movement between the second elongated assembly 200 and the first elongated assembly 100. The first elongated assembly 100 includes a head section truss member 131.

Referring to the embodiment as depicted in FIG. 1C, the winch assembly 250 is configured to control the movement (take-in, take-out) of the second cable 222. The second cable 222 is fixedly attached to the brake assembly 500. At least one portion of the brake assembly 500 is fixedly attached to the tail section truss member 132 of the first elongated assembly 100. The first cable 221 is fixedly attached to a first connection point 112. A turnbuckle assembly 160 is fixedly attached to the first connection point 112. A take-up member 108 is fixedly attached to another end portion of the turnbuckle assembly 160. The turnbuckle assembly 160 is configured to apply a predetermined or desired amount of tension to the first cable 221 (to take up unrequired slack, etc.). A tension spring 161 is configured to adjust the amount of tension on the first cable 221 during the take-up or the take-out of the first cable 221 relative to the winch assembly 250. The tension spring 161 is operatively mounted to a tail section truss member 132 of the first elongated assembly 100.

Referring to the embodiment as depicted in FIG. 1C, the winch assembly 250 is configured to be mounted to a tail section truss 241 of the second elongated assembly 200, and a head section truss 242 of the second elongated assembly 200. The first elongated assembly 100 includes the head-end section 133 and a tail-end section 134 spaced apart from the head-end section 133. The second elongated assembly 200 includes a tail-end section 243 and a head-end section 244 spaced apart from the head-end section 244.

Referring to the embodiment as depicted in FIG. 1C, the take-up member 108 is configured to support the tension spring 161 at the tail section truss member 132 of the first elongated assembly 100. The tension spring 161 is configured to adjust tension in the first cable 221 for optimal operation thereof. First and second target plates (162A, 162B) are spaced apart from each other. A tension limit switch 163 is configured to provide a switch signal to be detected or received by the PLC (Programmable Logic Controller, known and not depicted). The switch signal is configured to urge the PLC (as appropriately programmed) to halt or suspend relative movement of the second elongated assembly 200, etc. and/or other operations in response to the PLC receiving the switch signal. The switch signal is configured to indicate non-optimal conditions. A switch support member 164 is configured to support the tension limit switch 163.

Referring to the embodiment as depicted in FIG. 1D, a load cell 170 may be mounted to the first elongated assembly 100, and is configured to be attached (at least in part) to the second cable 222. The load cell 170 is configured to provide a load-cell signal for signal communication with a PLC (programmable logic controller, not depicted and known). The PLC may be configured to halt operation of the winch assembly 250 in response to receiving the load-cell signal having a predetermined attribute (magnitude). For instance, a safety pin limit switch 174 is configured to receive a movement-control signal from PLC to control (stop or start) the operation of the winch assembly 250. A safety drop pin 172 is configured to cooperate with the safety pin limit switch 174. The safety pin limit switch 174 is configured to control the movement of the safety drop pin 172 to engage or disengage the operation of the winch assembly 250, as may be required.

Referring to the embodiments as depicted in FIG. 1E and FIG. 1F, the first elongated assembly 100 has an elongated length 103, and also has first structural members 105. The first support wheels 190 are configured to assist in the linear movement of the first elongated assembly 100 (when needed as such). The second support wheels 192 are configured to assist in side-to-side angular movement of the first elongated assembly 100 (when needed). An elevation actuator assembly 194 is configured to lift or lower to thereby adjust the angled elevation (altitude) of the first elongated assembly 100 relative to the working surface 199 (as may be needed). A base assembly 196 rests on the working surface 199 (the ground) and is configured to support the first elongated assembly 100.

Referring to the embodiments as depicted in FIG. 1E and FIG. 1F, the first elongated assembly 100 may be configured for pivotal movement along the pivotal movement direction 198 (side-to-side angled movement direction), as may be needed.

Referring to the embodiments as depicted in FIG. 2 and FIG. 3, the complementary engagement feature 400 (also called a brake or a brake assembly) includes and is not limited to a first frame assembly 402. The first frame assembly 402 is configured to be fixedly attached or mounted to the first elongated assembly 100. This is done, preferably, so that the first frame assembly 402 spans, at least in part, across the opposite elongated lateral sides of the first elongated assembly 100. The complementary engagement feature 400 also includes and is not limited to a slide coupler 402A. The slide coupler 402A is configured to be fixedly attached, preferably, to a midsection or a portion of the first frame assembly 402. The complementary engagement feature 400 also includes and is not limited to a slide member 403A. The slide member 403A is configured to be slidably coupled to the slide coupler 402A. This is done in such a way that the slide member 403A, in use, reciprocally slides (in a back-and-forth manner) along the elongated length 103 of the first elongated assembly 100 relative to the first frame assembly 402. The slide member 403A is configured to be, preferably, slide receivable, at least in part, within the slide coupler 402A. The slide member 403A is configured to extend, at least in part, externally from opposite sides of the slide coupler 402A while the slide member 403A is made to slidably move. The complementary engagement feature 400 also includes and is not limited to a second frame assembly 403. The second frame assembly 403 is fixedly attached to a first end portion of the slide member 403A. This is done in such a way that the second frame assembly 403, in use, is reciprocally movable with the slide member 403A, in a back-and-forth manner, along the elongated length 103 of the first elongated assembly 100 relative to the first frame assembly 402. It will be appreciated that the first frame assembly 402 remains fixed to the first elongated assembly 100 and does not move relative to the elongated length 103. The complementary engagement feature 400 also includes and is not limited to a tension connector 402B. The tension connector 402B is fixedly attached to a second end portion of the slide member 403A, opposite from the first end portion of the slide member 403A. The tension connector 402B is configured to be fixedly attachable to the tension line 412 and/or any equivalent thereof, such as the second cable 222 (as depicted in FIG. 1C or 1D).

Referring to the embodiments as depicted in FIG. 2 and FIG. 3, the complementary engagement feature 400 also includes and is not limited to a shaped member 404. The shaped member 404 is configured to be rotatably mounted (pivotally mounted), either directly or indirectly, to the first frame assembly 402. The first frame assembly 402 preferably includes and is not limited to spaced-apart guide plates 414 extending, at least in part, from the first frame assembly 402 along, at least in part, the elongated length of the first elongated assembly 100. The shaped member 404 is configured to be positioned between the spaced-apart guide plates 414. The spaced-apart guide plates 414 are configured to limit side-to-side movement of the shaped member 404 in such a way that (A) the shaped member 404 is prevented from moving between the opposite elongated lateral sides of the first elongated assembly 100, and (B) the shaped member 404 is maintained or guided to be selectively movable toward (as depicted in FIG. 3), and away from (as depicted in FIG. 2), the second elongated assembly 200. Preferably, the spaced-apart guide plates 414 include and are not limited to: (A) first spaced-apart guide plates 414A securely positioned at a first elongated lateral side of the first frame assembly 402, and (B) second spaced-apart guide plates 414B securely positioned at a second elongated lateral side of the first frame assembly 402. The second spaced-apart guide plates 414B are spaced apart from the first spaced-apart guide plates 414A. The shaped member 404 includes a first shaped member 404A and a second shaped member 404B that is spaced apart from a first shaped member 404A. The first spaced-apart guide plates 414A are provided for the first shaped member 404A of the shaped member 404. The second spaced-apart guide plates 414B are provided for the second shaped member 404B of the shaped member 404. A pivot member 405 includes and is not limited to: (A) a first pivot member 405A for use with the first shaped member 404A, and (B) a second pivot member (hidden in the views of FIG. 2 and FIG. 3) for use with the second shaped member 404B. The pivot member 405 is configured to: (A) pivotally couple the shaped member 404 to (either directly or indirectly) the first frame assembly 402, and (B) more preferably pivotally couple the shaped member 404 directly to the spaced-apart guide plates 414. In accordance with a preferred embodiment, the pivot member 405 includes and is not limited to: (A) a first pivot member 405A for use with the first shaped member 404A, and (B) a second pivot member (hidden in the views of FIG. 2 and FIG. 3) for use with the second shaped member 404B. In accordance with a preferred embodiment, the first pivot member 405A is configured to preferably pivotally couple the first shaped member 404A directly to the first spaced-apart guide plates 414A. In accordance with a preferred embodiment, the second pivot member (not depicted in FIG. 2 and FIG. 3) is configured to preferably pivotally couple the second shaped member 404B directly to the second spaced-apart guide plates 414B.

Referring to the embodiments as depicted in FIG. 2 and FIG. 3, the complementary engagement feature 400 also includes and is not limited to an actuator assembly 406. The actuator assembly 406 is configured to selectively move the second frame assembly 403 relative to the first frame assembly 402 in such a way that the second frame assembly 403 is selectively reciprocally movable, at least in part, in a selective back-and-forth manner along, at least in part, the elongated length of the first elongated assembly 100. A first section (or portion) of the actuator assembly 406 is fixedly attached to the first frame assembly 402. A second section (or portion) of the actuator assembly 406 is fixedly attached to the second frame assembly 403. The first frame assembly 402 is stationary relative to the second frame assembly 403, and the second frame assembly 403 is movable, at least in part, along the elongated length of the first elongated assembly 100. The actuator assembly 406 preferably includes a spring assembly 409. The spring assembly 409 preferably includes and is not limited to: (A) a first spring assembly 409A positioned proximate to the first shaped member 404A, and (B) a second spring assembly 409B positioned proximate to the second shaped member 404B. The first spring assembly 409A is configured to apply a force to selectively move the first shaped member 404A. The second spring assembly 409B is configured to apply a force to selectively move the second shaped member 404B.

Referring to the embodiments as depicted in FIG. 4, the complementary engagement feature 400 and the spaced-apart engagement features 300 are not selectively engaged with (but are selectively disengaged from) each other. This disengagement arrangement permits relative free movement between the first elongated assembly 100 and the second elongated assembly 200. More specifically, the shaped member 404 is moved away from the selectable engagement feature 301 thereby permitting relative (free) movement between the first elongated assembly 100 and the second elongated assembly 200.

Referring to the embodiments as depicted in FIG. 4, for the case where a movement force 417 applies a first amount of force or tension to the tension line 412, there is selective disengagement between a portion (such as the selectable engagement feature 301) of the spaced-apart engagement features 300 and a portion (such as the first shaped member 404A) of the complementary engagement feature 400. For this case, free relative movement is permitted between the first and second elongated assemblies (100, 200). This is done in such a way that the tension line 412 transmits a force (either directly or indirectly) to the spring assembly 409, and in response, the spring assembly 409 becomes compressed to urge a portion (such as the first shaped member 404A) of the complementary engagement feature 400 to move away from, and become selectively disengaged from, a portion (such as the selectable engagement feature 301) of the spaced-apart engagement features 300.

Referring to the embodiments as depicted in FIG. 5, for the case where the movement force 417 applies a second amount of force or tension to the tension line 412, there is selective engagement between a portion (such as the selectable engagement feature 301) of the spaced-apart engagement features 300 and a portion (such as the first shaped member 404A) of the complementary engagement feature 400. The second amount of force is lower than (less than) the first amount of force or tension. This is done in such a way that the second amount of force is transmitted through the tension line 412 (either directly or indirectly) to the spring assembly 409 so that the spring assembly 409 may become relaxed to permit movement of the complementary engagement feature 400 into secured engagement with at least one engagement feature of the spaced-apart engagement features 300. For this case, relative movement is halted between the first and second elongated assemblies (100, 200) in response to this secured engagement with at least one engagement feature.

Referring to the embodiments as depicted in FIG. 4 and FIG. 5, the linkage assembly 410 is configured to link the second frame assembly 403 with the shaped member 404. The shaped member 404 includes and is not limited to an L-shaped body member (and/or any equivalent thereof). The shaped member 404 is rotatably or pivotally mounted to the first frame assembly 402, preferably via a pivot member 405. The first shaped member 404A is rotatably or pivotally mounted to the first frame assembly 402, preferably via a first pivot member 405A. In accordance with a preferred embodiment, the linkage assembly 410 includes and is not limited to (A) a first linkage assembly 410A for use with the first shaped member 404A positioned at a first elongated lateral side of the first elongated assembly 100, and (B) a second linkage assembly (not depicted in the views of FIG. 4 or FIG. 5) for use with the second shaped member 404B positioned at a second elongated lateral side of the first elongated assembly 100. The linkage assembly 410 is configured to selectively pivotally reciprocally rotate a portion (such as the shaped member 404) of the complementary engagement feature 400 in response to selective movement of the second frame assembly 403 due to selective actuation of the actuator assembly 406, such as (and not limited to) compression or decompression of the spring assembly 409 (and/or any equivalent thereof).

Referring to the embodiments as depicted in FIG. 4 and FIG. 5, the linkage assembly 410 includes and is not limited to (A) a first link connection 411A configured to pivotally connect a first end portion of the linkage assembly 410 to a portion (such as the shaped member 404) of the complementary engagement feature 400, and (B) a second link connection 411B configured to pivotally connect a second end portion of the linkage assembly 410 to the second frame assembly 403. The first link connection 411A is configured to selectively reciprocally move along a movement direction 419 in response to the selective movement of the second frame assembly 403 under the influence of the actuator assembly 406 (such as the spring assembly 409). A tension connector 402B is fixedly attached to the slide member 403A. A lug 421 is fixedly attached to the tension connector 402B. The tension line 412 is configured to be fixedly attached to the lug 421.

Referring to the embodiments as depicted in FIG. 5, the complementary engagement feature 400 and the spaced-apart engagement features 300 are selectively engaged (latched) with each other in such a way that relative movement is halted (at least in part) between the first elongated assembly 100 and the second elongated assembly 200. More specifically, the shaped member 404 is moved into secured engagement with the selectable engagement feature 301 thereby halting relative movement between the first elongated assembly 100 and the second elongated assembly 200.

Referring to the embodiments as depicted in FIG. 5, the spring assembly 409 decompresses to move the second frame assembly 403 along a retraction direction 423, so that the complementary engagement feature 400 becomes disengaged from the selectable engagement feature 301 of the spaced-apart engagement features 300.

Referring to the embodiments as depicted in FIG. 4 and FIG. 5, the shaped member 404 includes preferably an L-shaped member and/or any equivalent thereof. The shaped member 404 includes a first outer edge portion 407A configured to selectively securely engage with (contactable abut against) a first inner edge portion 307A of the selectable engagement feature 301. The shaped member 404 also includes a second outer edge portion 407B having a sloped edge configured to permit free lateral movement of the second elongated assembly 200 so that the shaped member 404 does not become inadvertently jammed at an inconvenient time. The second outer edge portion 407B is spaced apart opposite from the first outer edge portion 407A.

Referring to the embodiments as depicted in FIG. 5, the selectable engagement feature 301 includes (A) a first selectable engagement feature 301A for deployment to a first elongated lateral side of the first elongated assembly 100, and (B) a second selectable engagement feature 301B (depicted in FIG. 7) for deployment to a second elongated lateral side of the first elongated assembly 100. The first selectable engagement feature 301A includes first and second inner edge portions (307A, 307B) which are spaced apart from each other. The sloped edge of the second outer edge portion 407B is configured strike the second inner edge portion 307B but permit slide movement of the shaped member 404 thereby preventing inadvertent (unwanted) jamming of the shaped member 404 with the spaced-apart engagement features 300.

Referring to the embodiments as depicted in FIG. 6, the second elongated assembly 200 includes a second material-moving conveyor 204. The spaced-apart engagement features 300 include spaced-apart grooves (302A, 302B, 302C, 302D, 302E). The elongated member 304 preferably defines a first groove 302A, a second groove 302B, a third groove 302C, a fourth groove 302D, and a fifth groove 302E, etc.

Referring to the embodiments as depicted in FIG. 6, the spaced-apart engagement features 300 include a first spaced-apart engagement feature 300A and a second spaced-apart engagement feature 300B.

Referring to the embodiments as depicted in FIG. 7 the spaced-apart engagement features 300 include a first spaced-apart engagement feature 300A and a second spaced-apart engagement feature 300B. The selectable engagement feature 301 includes (A) a first neighboring engagement feature 303A, which may include a first neighboring groove and/or any equivalent thereof, and (B) a second neighboring engagement feature 303B which include a second neighboring groove and/or any equivalent thereof.

Referring to the embodiments as depicted in FIG. 7, the spaced-apart engagement features 300 include a selectable engagement feature 301, a first selectable engagement feature 301A and a second selectable engagement feature 301B, etc.

Referring to the embodiments as depicted in FIG. 8, the first spring assembly 409A is compressed and moves along a spring-operation direction 408.

Referring to the embodiments as depicted in FIG. 8, the shaped member 404 includes a first shaped member 404A including, preferably, an L-shaped member or any equivalent thereof.

Referring to the embodiments as depicted in FIG. 9 and FIG. 10, the first elongated assembly 100 includes first structural members 105. The linkage assembly 410 is selectively movable along a link movement direction 413. The shaped member 404 is selectively rotated along a movement direction 415.

### Additional Description

The following clauses are offered as further descriptions of the embodiments of the apparatus. Any one or more of the following clauses may be combinable with any other one or more of the following clauses and/or with any subsection or a portion or portions of any other clause and/or combination and permutation of clauses. Any one of the following clauses may stand on its own merit without having to be combined with any other clause or with any portion of any other clause, etc.
Clause (1): an apparatus (either taken alone, or with an apparatus of any clause mentioned in this additional description, or any portion of any clause mentioned in this additional description) includes and is not limited to (with reference to FIG. 1A, FIG. 1B, FIG. 1C, FIG. 1D, FIG. 1E and FIG. 1F) a first elongated assembly 100; and a second elongated assembly 200 movable, at least in part, along an elongated movement axis 201 (aka a linear movement axis) relative to the first elongated assembly 100; and a brake assembly 500 (also called means for selectable engagement such as, and not limited to, the synergistic combination of (A) spaced-apart engagement features 300 and (B) a complementary engagement feature 400); and the brake assembly 500 configured to selectively securely engage (latch, either directly or indirectly) the first elongated assembly 100 and the second elongated assembly 200 together to thereby halt, at least in part, relative movement between the first elongated assembly 100 and the second elongated assembly 200; and the brake assembly 500 having brake features (such as and not limited to spaced-apart grooves (302A, 302B, 302C, 302D, 302E) serially positionable, one after another, in a spaced-apart close intimate arrangement (relationship); and the brake features of the brake assembly 500 also coaxially alignable, at least in part, along the elongated movement axis 201.
Clause (2): an apparatus (either taken alone, or with an apparatus of any clause mentioned in this additional description, or any portion of any clause mentioned in this additional description) includes and is not limited to (with reference to FIG. 1A and/or FIG. 1B) a brake assembly 500 including (and not limited to): spaced-apart engagement features 300 that are fixedly mounted to the second elongated assembly; and complementary engagement feature 400 fixedly mounted to the first elongated assembly 100; and the spaced-apart engagement features 300 and the complementary engagement feature 400 configured to cooperatively halt, at least in part, relative movement between the first elongated assembly 100 and the second elongated assembly 200.
Clause (3): an apparatus (either taken alone, or with an apparatus of any clause mentioned in this additional description, or any portion of any clause mentioned in this additional description) includes and is not limited to (with reference to FIG. 1A, FIG. 1B, FIG. 4, and FIG. 6) a first elongated assembly 100; and a second elongated assembly 200 movable, at least in part, along an elongated movement axis 201 (aka a linear movement axis), relative to the first elongated assembly 100; and spaced-apart engagement features 300 including a selectable engagement feature 301, and having spaced-apart grooves (302A, 302B, 302C, 302D, 302E) serially positionable, one after another, in a spaced-apart close intimate arrangement (relationship), and also coaxially alignable, at least in part, along the elongated movement axis 201; and the first elongated assembly 100 and the second elongated assembly 200 selectively securely engageable (latchable, either directly or indirectly) together at the selectable engagement feature 301 to thereby halt, at least in part, relative movement between the second elongated assembly 200 and the first elongated assembly 100.
Clause (4): an apparatus (either taken alone, or with an apparatus of any clause mentioned in this additional description, or any portion of any clause mentioned in this additional description) includes and is not limited to (with reference to FIG. 1A, FIG. 1B, FIG. 4 and FIG. 7) a complementary engagement feature 400 configured to be selectively securely engageable (latchable) with the selectable engagement feature 301 to thereby halt, at least in part, relative movement between the second elongated assembly 200 and the first elongated assembly 100.
Clause (5): an apparatus (either taken alone, or with an apparatus of any clause mentioned in this additional description, or any portion of any clause mentioned in this additional description) includes and is not limited to (with reference to FIG. 1A and/or FIG. 1B) spaced-apart engagement features 300 fixedly mounted to the second elongated assembly 200; and the complementary engagement feature 400 is fixedly mounted to the first elongated assembly 100.
Clause (6): an apparatus (either taken alone, or with an apparatus of any clause mentioned in this additional description, or any portion of any clause mentioned in this additional description) includes and is not limited to (with reference to FIG. 1A, FIG. 1B, FIG. 4, FIG. 5, and FIG. 6) a first elongated assembly 100 having first structural members 105, and also having an elongated longitudinal axis 101 extending along an elongated length 103 of the first elongated assembly 100; and a second elongated assembly 200 having second structural members 205, and the second elongated assembly 200 configured to be movable relative to the first elongated assembly 100 along an elongated movement axis 201, and the second elongated assembly 200 also configured to be coaxially alignable relative to the elongated longitudinal axis 101 of the first elongated assembly 100; and spaced-apart engagement features 300 including a selectable engagement feature 301, and the spaced-apart engagement features 300 having spaced-apart grooves (302A, 302B, 302C, 302D, 302E) configured to be coaxially alignable, at least in part, relative to the elongated movement axis 201; and the spaced-apart engagement features 300 also configured to be serially positionable, one after another, in a spaced-apart close intimate arrangement (relationship) along (to) the second structural members 205 of the second elongated assembly 200; and wherein: the first elongated assembly 100 and the second elongated assembly 200 are selectively securely engageable (latchable) together at the selectable engagement feature 301 to halt, at least in part, relative movement between the second elongated assembly 200 and the first elongated assembly 100 in response to the first elongated assembly 100 and the second elongated assembly 200 becoming selectively securely engaged at (with) the selectable engagement feature 301.
Clause (7): an apparatus (either taken alone, or with an apparatus of any clause mentioned in this additional description, or any portion of any clause mentioned in this additional description), includes and is not limited to (with reference to FIG. 1A, FIG. 1B, and FIG. 4) a complementary engagement feature 400 configured to be securely fixedly supportable to the first structural members 105 of the first elongated assembly 100; and the complementary engagement feature 400 selectively securely engageable (latchable) with the selectable engagement feature 301 to halt, at least in part, relative movement between the second elongated assembly 200 and the first elongated assembly 100.
Clause (8): an apparatus (either taken alone, or with an apparatus of any clause mentioned in this additional description, or any portion of any clause mentioned in this additional description) includes and is not limited to a first elongated assembly 100 having first structural members 105, and also having an elongated longitudinal axis 101 extending along an elongated length 103 of the first elongated assembly 100; and a second elongated assembly 200 having second structural members 205, and the second elongated assembly 200 configured to be telescopically extendable and movable relative to the first elongated assembly 100 along an elongated movement axis 201 coaxially aligned relative to the elongated longitudinal axis 101 of the first elongated assembly 100; and the spaced-apart engagement features 300 having a selectable engagement feature 301; and the spaced-apart engagement features 300 having spaced-apart grooves (302A, 302B, 302C, 302D, 302E) configured to be serially linearly securely located and positioned, at least in part, in a spaced-apart close intimate arrangement (relationship) longitudinally along at least some of the second structural members 205 of the second elongated assembly 200; and the spaced-apart engagement features 300 also configured to be, at least in part, coaxially aligned relative to the elongated movement axis 201 (and/or the elongated longitudinal axis 101 of the first elongated assembly 100); and a complementary engagement feature 400 configured to be securely supported by (fixedly mounted to) the first structural members 105 of the first elongated assembly 100; and the complementary engagement feature 400 selectively securely engageable (latchable) to the selectable engagement feature 301 of the spaced-apart engagement features 300; this is done in such a way that selective secured engagement of the complementary engagement feature 400 with (at) the selectable engagement feature 301, in use, halts, at least in part, relative movement between the second elongated assembly 200 and the first elongated assembly 100.
Clause (9): an apparatus (either taken alone, or with an apparatus of any clause mentioned in this additional description, or any portion of any clause mentioned in this additional description) includes and is not limited to (with reference to FIG. 4) a complementary engagement feature 400 configured to apply a halting force (a breaking force) to the selectable engagement feature 301.
Clause (10): an apparatus (either taken alone, or with an apparatus of any clause mentioned in this additional description, or any portion of any clause mentioned in this additional description) includes and is not limited to (with reference to FIG. 4) a complementary engagement feature 400 configured to be selectively disengageable from the selectable engagement feature 301 securely positioned to the first structural members 105 of the first elongated assembly 100.
Clause (11): an apparatus (either taken alone, or with an apparatus of any clause mentioned in this additional description, or any portion of any clause mentioned in this additional description) includes and is not limited to (with reference to FIG. 5) a complementary engagement feature 400 configured to be selectively securely engageable (latchable) with the selectable engagement feature 301 in such a way that secure engagement (directly or indirectly) between the complementary engagement feature 400 and the selectable engagement feature 301, in cooperative action, halts, at least in part, relative movement between the second elongated assembly 200 and the first elongated assembly 100.
Clause (12): an apparatus (either taken alone, or with an apparatus of any clause mentioned in this additional description, or any portion of any clause mentioned in this additional description) includes and is not limited to (with reference to FIG. 6) spaced-apart engagement features 300 including (and not limited to): an elongated member 304 configured to be mounted (directly or indirectly) to, and along, an elongated length of the second elongated assembly 200; and the elongated member 304 defining, at least in part, spaced-apart grooves (302A, 302B, 302C, 302D, 302E) serially aligned along an elongated length of the elongated member 304.
Clause (13): an apparatus (either taken alone, or with an apparatus of any clause mentioned in this additional description, or any portion of any clause mentioned in this additional description) includes and is not limited to (with reference to FIG. 4) a complementary engagement feature 400 configured to be coupled to a tension line 412. A portion (such as the shaped member 404) of the complementary engagement feature 400 is also configured to biasedly disengage away from a portion (such as the first inner edge portion 307A) of the selectable engagement feature 301 in response to an increase of tension of (in) the tension line 412 so that the first elongated assembly 100 and the second elongated assembly 200 are movable relative to each other.
Clause (14): an apparatus (either taken alone, or with an apparatus of any clause mentioned in this additional description, or any portion of any clause mentioned in this additional description) includes and is not limited to (with reference to FIG. 4) a complementary engagement feature 400 configured to be coupled to a tension line 412. A portion (such as a shaped member 404) of the complementary engagement feature 400 is also configured to selectively disengage, and move away, from any engagement with a portion (such as the first inner edge portion 307A) of the selectable engagement feature 301 in response to an increase in tension in the tension line 412 in such a way that the portion (such as the shaped member 404) of the complementary engagement feature 400 becomes placed (positioned) in a disengaged relationship from the portion (such as the first inner edge portion 307A) of the selectable engagement feature 301 so that relative movement is permitted between the second elongated assembly 200 and the first elongated assembly 100.
Clause (15): an apparatus (either taken alone, or with an apparatus of any clause mentioned in this additional description, or any portion of any clause mentioned in this additional description) includes and is not limited to (with reference to FIG. 5) a complementary engagement feature 400 configured to be coupled (directly or indirectly) to a tension line 412. A portion (such as a shaped member 404) of the complementary engagement feature 400 is also configured to biasedly securely engage with a portion (such as a first inner edge portion 307A) of the selectable engagement feature 301 in response to an increase in tension of the tension line 412 so that relative movement between the first elongated assembly 100 and the second elongated assembly 200 is halted (arrested).
Clause (16): an apparatus (either taken alone, or with an apparatus of any clause mentioned in this additional description, or any portion of any clause mentioned in this additional description) includes and is not limited to (with reference to FIG. 5) a complementary engagement feature 400 configured to be coupled to a tension line 412; and a portion (such as a shaped member 404) of the complementary engagement feature 400 is also configured to selectively securely engage with a portion (such as a first inner edge portion 307A) of the selectable engagement feature 301 in response to a reduction (relaxation) in tension in the tension line 412 in such a way that the portion (such as the shaped member 404) of the complementary engagement feature 400 engages with the portion (such as the first inner edge portion 307A) of the selectable engagement feature 301 so that relative movement is halted (prevented), at least in part, between the second elongated assembly 200 and the first elongated assembly 100.
Clause (17): an apparatus (either taken alone, or with an apparatus of any clause mentioned in this additional description, or any portion of any clause mentioned in this additional description) includes and is not limited to (with reference to FIG. 4 and FIG. 5) a complementary engagement feature 400 configured to be selectively engageable with, or selectively disengageable from, the selectable engagement feature 301 between: (A) an intimate secured contact engagement (as depicted in FIG. 5) in which a portion (such as the shaped member 404) of the complementary engagement feature 400 engages with a portion (such as the first inner edge portion 307A) of the selectable engagement feature 301 thereby halting relative movement between the first elongated assembly 100 and the second elongated assembly 200; and (B) a non-contact engagement (as depicted in FIG. 4) in which the complementary engagement feature 400 remains unengaged with the selectable engagement feature 301 thereby permitting relative movement between the first elongated assembly 100 and the second elongated assembly 200.
Clause (18): an apparatus (either taken alone, or with an apparatus of any clause mentioned in this additional description, or any portion of any clause mentioned in this additional description) includes and is not limited to (with reference to FIG. 4 and FIG. 5) a selectable engagement feature 301 of the spaced-apart engagement features 300 sized to be proximately larger than (such as a shaped member 404) of the complementary engagement feature 400 to facilitate movement of (such as the shaped member 404) of the complementary engagement feature 400 into engagement with the selectable engagement feature 301.
Clause (19): an apparatus (either taken alone, or with an apparatus of any clause mentioned in this additional description, or any portion of any clause mentioned in this additional description) includes and is not limited to (with reference to FIG. 7) a selectable engagement feature 301 of the spaced-apart engagement features 300. The selectable engagement feature 301 is positionable (positioned) in a relatively close proximate relationship to the first and second neighboring engagement features (303A, 303B), such as first and second neighboring grooves, along or in a linear relationship.
Clause (20): an apparatus (either taken alone, or with an apparatus of any clause mentioned in this additional description, or any portion of any clause mentioned in this additional description) includes and is not limited to (with reference to FIG. 7) the spaced-apart engagement features 300 having spaced-apart grooves (302A, 302B, 302C, 302D, 302E) each configured to be in a selective close intimate contact relationship (engagement) with (such as the shaped member 404) of the complementary engagement feature 400 in response to selective close intimate engagement to be made between a selected one of the spaced-apart engagement features 300 and a portion of (such as the shaped member 404) of the complementary engagement feature 400.
Clause (21): an apparatus (either taken alone, or with an apparatus of any clause mentioned in this additional description, or any portion of any clause mentioned in this additional description) includes and is not limited to (with reference to FIG. 4 and FIG. 5) the complementary engagement feature 400 which is also configured to be coupled to a tension line 412.
Clause (22): an apparatus (either taken alone, or with an apparatus of any clause mentioned in this additional description, or any portion of any clause mentioned in this additional description) includes and is not limited to (with reference to FIG. 6) the spaced-apart engagement features 300 including (and not limited to): an elongated member 304 configured to be attached, at least in part, to the second structural members 205 of the second elongated assembly 200; and the elongated member 304 defining, at least in part, spaced-apart grooves (302A, 302B, 302C, 302D, 302E) aligned along an elongated length of the elongated member 304.
Clause (23): an apparatus (either taken alone, or with an apparatus of any clause mentioned in this additional description, or any portion of any clause mentioned in this additional description) includes and is not limited to (with reference to FIG. 7) a complementary engagement feature 400 including (and not limited to): a first frame assembly 402 configured to be fixedly attached to the first elongated assembly 100; and a second frame assembly 403 configured to be movable relative to the first frame assembly 402.
Clause (24): an apparatus (either taken alone, or with an apparatus of any clause mentioned in this additional description, or any portion of any clause mentioned in this additional description) includes and is not limited to (with reference to FIG. 4 and FIG. 5) a complementary engagement feature 400 including (and not limited to): a shaped member 404 (preferably, an L-shaped member) operatively mounted (pivotally mounted) to the first frame assembly 402; and the shaped member 404 configured to be movable into the selectable engagement feature 301 (as depicted in FIG. 5); and the shaped member 404 also configured to be movable out from the selectable engagement feature 301 (as depicted in FIG. 4).
Clause (25): an apparatus (either taken alone, or with an apparatus of any clause mentioned in this additional description, or any portion of any clause mentioned in this additional description) includes and is not limited to (with reference to FIG. 4 and FIG. 5) a shaped member 404 configured to be pivotally mounted (preferably via a first pivot member 405A) to the first frame assembly 402.
Clause (26): an apparatus (either taken alone, or with an apparatus of any clause mentioned in this additional description, or any portion of any clause mentioned in this additional description) includes and is not limited to (with reference to FIG. 4 and FIG. 5) a complementary engagement feature 400 including (and not limited to): an actuator assembly 406 configured to actuate selective movement of the shaped member 404 into (or out from) the selectable engagement feature 301.
Clause (27): an apparatus (either taken alone, or with an apparatus of any clause mentioned in this additional description, or any portion of any clause mentioned in this additional description) includes and is not limited to (with reference to FIG. 4 and FIG. 5) an actuator assembly 406 including (and not limited to): a spring assembly 409 configured to be selectively (A) compressed (in response to an increased application of tension to the spring assembly 409, as depicted in FIG. 4) and (B) decompressed (in response to a reduction of tension to the spring assembly 409); and the spring assembly 409 also configured to biasedly engage a portion (such as the shaped member 404) of the complementary engagement feature 400 with a portion (such as the first inner edge portion 307A) of the selectable engagement feature 301.
Clause (28): an apparatus (either taken alone, or with an apparatus of any clause mentioned in this additional description, or any portion of any clause mentioned in this additional description) includes and is not limited to (with reference to FIG. 4 and FIG. 5) an actuator assembly 406 including (and not limited to) a tension line 412 configured to be coupled (either directly or indirectly) to the spring assembly 409; and wherein in response to increased tension in the tension line 412, the spring assembly 409 becomes compressed to thereby securely engage the complementary engagement feature 400 with the selectable engagement feature 301 (as depicted in FIG. 4); and wherein in response to decreased tension in the tension line 412, the spring assembly 409 becomes relaxed to thereby disengage the complementary engagement feature 400 with the selectable engagement feature 301 (as depicted in FIG. 5).
Clause (29): an apparatus (either taken alone, or with an apparatus of any clause mentioned in this additional description, or any portion of any clause mentioned in this additional description) includes and is not limited to (with reference to FIG. 5) a spring assembly 409 configured to biasedly disengage a complementary engagement feature 400 away from the selectable engagement feature 301 in response to a reduction in tension, at least in part, of the tension line 412 in such a way that the spring assembly 409 urges the complementary engagement feature 400 away from the selectable engagement feature 301 to permit relative movement between the first elongated assembly 100 and the second elongated assembly 200.
Clause (30): an apparatus (either taken alone, or with an apparatus of any clause mentioned in this additional description, or any portion of any clause mentioned in this additional description) includes and is not limited to (with reference to FIG. 4) a spring assembly 409 configured to securely biasedly engage the complementary engagement feature 400 with the selectable engagement feature 301 in response to an increase in tension of the tension line 412 in such a way that the spring assembly 409 urges, in use, the complementary engagement feature 400 to securely engage the selectable engagement feature 301 to halt, at least in part, relative movement between the first elongated assembly 100 and the second elongated assembly 200.
Clause (31): an apparatus (either taken alone, or with an apparatus of any clause mentioned in this additional description, or any portion of any clause mentioned in this additional description) includes and is not limited to (with reference to FIG. 4 and FIG. 5) a spring assembly 409 configured to operate along a spring-operation direction 408 coaxially aligned, at least in part, relative to the tension line 412 placed under tension.
Clause (32): an apparatus (either taken alone, or with an apparatus of any clause mentioned in this additional description, or any portion of any clause mentioned in this additional description) includes and is not limited to (with reference to FIG. 4 and FIG. 5) a complementary engagement feature 400 including (and not limited to): a spring assembly 409.
Clause (33): an apparatus (either taken alone, or with an apparatus of any clause mentioned in this additional description, or any portion of any clause mentioned in this additional description) includes and is not limited to (with reference to FIG. 5) a complementary engagement feature 400 including (and not limited to): a linkage assembly 410 configured to link, either directly or indirectly, the complementary engagement feature 400 with the spring assembly 409; and wherein the linkage assembly 410 is configured to urge movement of the complementary engagement feature 400 away from the selectable engagement feature 301 in response to a reduction in tension of the tension line 412.
Clause (34): an apparatus (either taken alone, or with an apparatus of any clause mentioned in this additional description, or any portion of any clause mentioned in this additional description) includes and is not limited to (with reference to FIG. 4) a linkage assembly 410 configured to securely engage, in cooperation with a spring assembly 409, the complementary engagement feature 400 with the selectable engagement feature 301 in response to an application of tension to the tension line 412.
Clause (35): a method (either taken alone, or with a method of any clause mentioned in this additional description, or any portion of any clause mentioned in this additional description) includes and is not limited to (with reference to FIG. 4 and FIG. 5) the following steps: the method is for operating a first elongated assembly 100, and a second elongated assembly 200 movable relative to the first elongated assembly 100 along an elongated movement axis 201, with the spaced-apart engagement features 300 including a selectable engagement feature 301, and the spaced-apart engagement features 300 having spaced-apart grooves (302A, 302B, 302C, 302D, 302E) serially positionable one after another in a spaced-apart close intimate arrangement (relationship), and the spaced-apart grooves (302A, 302B, 302C, 302D, 302E) coaxially alignable, at least in part, along the elongated movement axis 201. The method includes (and is not limited to): selectively securely engaging (latching) together at the selectable engagement feature 301 to thereby halt, at least in part, relative movement between the second elongated assembly 200 and the first elongated assembly 100.
Clause (36): a method (either taken alone, or with a method of any clause mentioned in this additional description, or any portion of any clause mentioned in this additional description) includes and is not limited to (with reference to FIG. 1A, FIG. 1B, FIG. 4, FIG. 5 and FIG. 6) the following steps: (A) positioning a first elongated assembly 100 (referring to FIG. 1A and/or FIG. 1B); and (B) positioning a second elongated assembly 200 movable relative to the first elongated assembly 100 along an elongated movement axis 201 (referring to FIG. 1A and/or FIG. 1B); and (C) serially positioning the spaced-apart engagement features 300 of a brake assembly 500 including a selectable engagement feature 301, with the spaced-apart engagement features 300 positioned one after another, in a spaced-apart close intimate arrangement (relationship) so that the spaced-apart engagement features 300 are coaxially aligned, at least in part, along the elongated movement axis 201 (referring to FIG. 6); and (D) selectively securely engaging (latching) together at the selectable engagement feature 301 to thereby halt, at least in part, relative movement between the second elongated assembly 200 and the first elongated assembly 100 (referring to FIG. 4 and FIG. 5).
Clause (37): an apparatus (either taken alone, or with an apparatus of any clause mentioned in this additional description, or any portion of any clause mentioned in this additional description), in which the apparatus is configured to be usable with a first elongated assembly 100 (aka a first elongated telescopically extendable assembly), and the apparatus also usable with a second elongated assembly 200 (aka a second elongated telescopically extendable assembly) movable, at least in part, along an elongated movement axis 201 (aka a linear movement axis), relative to the first elongated assembly 100. The apparatus includes (and is not limited to): a brake assembly 500 including and not limited to the spaced-apart engagement features 300, and the spaced-apart engagement features 300 including a selectable engagement feature 301, and with the spaced-apart engagement features 300 serially positionable, one after another, in a spaced-apart close intimate arrangement (relationship), and the spaced-apart engagement features 300 also coaxially alignable, at least in part, along the elongated movement axis 201; and the brake assembly 500 also including a complementary engagement feature 400 configured to be selectively securely engageable (latchable) with the selectable engagement feature 301.
Clause (38): an apparatus (either taken alone, or with an apparatus of any clause mentioned in this additional description, or any portion of any clause mentioned in this additional description), in which the apparatus is adapted such that a complementary engagement feature 400 is configured to halt, at least in part, relative movement between the second elongated assembly 200 and the first elongated assembly 100 in response to selective secured engagement (latchment) between the complementary engagement feature 400 and the selectable engagement feature 301.
Clause (39): an apparatus (either taken alone, or with an apparatus of any clause mentioned in this additional description, or any portion of any clause mentioned in this additional description) in which the apparatus is adapted so that the first elongated assembly 100 and the second elongated assembly 200 become selectively securely engageable (latchable, either directly or indirectly) together at the selectable engagement feature 301 in response to the complementary engagement feature 400, in use, selectively securely engaging (latching) with the selectable engagement feature 301 to thereby halt, at least in part, relative movement between the second elongated assembly 200 and the first elongated assembly 100.
Clause (40): an apparatus (either taken alone, or with an apparatus of any clause mentioned in this additional description, or any portion of any clause mentioned in this additional description), in which the apparatus is adapted such that the spaced-apart engagement features 300 are fixedly mounted to the second elongated assembly 200; and the complementary engagement feature 400 is fixedly mounted to the first elongated assembly 100.
Clause (41): an apparatus (either taken alone, or with an apparatus of any clause mentioned in this additional description, or any portion of any clause mentioned in this additional description), in which the apparatus is usable with a first elongated assembly 100 (aka a first elongated telescopically extendable assembly). The apparatus is also usable with a second elongated assembly 200 (aka a second elongated telescopically extendable assembly) movable, at least in part, along an elongated movement axis 201 (aka a linear movement axis), relative to the first elongated assembly 100. The apparatus is also usable with the spaced-apart engagement features 300 including a selectable engagement feature 301. The spaced-apart engagement features 300 are serially positionable, one after another, in a spaced-apart close intimate arrangement (relationship). The spaced-apart engagement features 300 are also coaxially alignable, at least in part, along the elongated movement axis 201. The apparatus includes and is not limited to: a brake assembly 500 including and not limited to a complementary engagement feature 400 configured to be selectively securely engageable (latchable) with the selectable engagement feature 301; and the complementary engagement feature 400 also configured to halt, at least in part, relative movement between the second elongated assembly 200 and the first elongated assembly 100 in response to selective secured engagement (latchment) between the complementary engagement feature 400 and the selectable engagement feature 301. It will be appreciated that for this case, (A) the spaced-apart engagement features 300 are installed to the second elongated assembly 200 (by the end user or by a first vendor), and (B) the complementary engagement feature 400 is provided by a second vendor not related to the prior or first vendor or end user.
Clause (42): an apparatus (either taken alone, or with an apparatus of any clause mentioned in this additional description, or any portion of any clause mentioned in this additional description), in which the apparatus is adapted such that the first elongated assembly 100 and the second elongated assembly 200 become selectively securely engageable (latchable, either directly or indirectly) together at the selectable engagement feature 301 in response to the complementary engagement feature 400, in use, selectively securely engaging (latching) with the selectable engagement feature 301 to thereby halt, at least in part, relative movement between the second elongated assembly 200 and the first elongated assembly 100.
Clause (43): An apparatus (either taken alone, or with an apparatus of any clause mentioned in this additional description, or any portion of any clause mentioned in this additional description), in which the apparatus is adapted such that the spaced-apart engagement features 300 are fixedly mounted to the second elongated assembly 200; and a complementary engagement feature 400 is fixedly mounted to the first elongated assembly 100.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the disclosure which does not materially modify the disclosure. Similarly, unless specifically made clear from its context, numerical values should be construed to include certain tolerances that the person skilled in the art would recognize as having negligible importance as they do not materially change the operability of the disclosure. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options may be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the disclosure. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a first elongated assembly; and
a second elongated assembly being movable, at least in part, along an elongated movement axis relative to the first elongated assembly;
a brake assembly being configured to selectively securely engage the first elongated assembly and the second elongated assembly together to thereby halt, at least in part, relative movement between the first elongated assembly and the second elongated assembly; and
said brake assembly including brake features;
at least some of said brake features being serially positionable, one after another, in a spaced-apart close intimate arrangement; and
said at least some of said brake features also being coaxially alignable, at least in part, along said elongated movement axis.

2. The apparatus of claim 1, wherein:
said at least some of said brake features of said brake assembly include spaced-apart engagement features fixedly mounted to the second elongated assembly; and
said brake assembly also includes a complementary engagement feature fixedly mounted to the first elongated assembly; and
said spaced-apart engagement features and said complementary engagement feature are configured to cooperatively halt, at least in part, relative movement between the first elongated assembly and the second elongated assembly.

3. An apparatus, comprising:
a first elongated assembly having first structural members, and also having an elongated longitudinal axis extending along an elongated length of the first elongated assembly;
a second elongated assembly having second structural members, and the second elongated assembly being configured to be telescopically extendable and movable relative to the first elongated assembly along an elongated movement axis being coaxially aligned relative to the elongated longitudinal axis of the first elongated assembly; and
a brake assembly including spaced-apart engagement features having a selectable engagement feature; and
the spaced-apart engagement features being configured to be serially linearly securely located and positioned, at least in part, in a spaced-apart close intimate arrangement longitudinally along at least some of said second structural members of the second elongated assembly;
the spaced-apart engagement features also being configured to be, at least in part, coaxially aligned relative to the elongated movement axis;
the brake assembly also including a complementary engagement feature being configured to be securely supported by the first structural members of the first elongated assembly; and
the complementary engagement feature being selectively securely engageable to said selectable engagement feature of said spaced-apart engagement features in such a way that selective secured engagement of the complementary engagement feature with said selectable engagement feature, in use, halts, at least in part, relative movement between the second elongated assembly and the first elongated assembly.

4. The apparatus of claim 3, wherein:
the spaced-apart engagement features have spaced-apart grooves; and
the complementary engagement feature is configured to apply a halting force to the selectable engagement feature.

5. The apparatus of claim 3, wherein:
the complementary engagement feature is configured to be selectively securely engageable with said selectable engagement feature in such a way that secure engagement between the complementary engagement feature and said selectable engagement feature, in cooperative action, halts, at least in part, relative movement between the second elongated assembly and the first elongated assembly.

6. The apparatus of claim 3, wherein:
said spaced-apart engagement features include:
an elongated member being configured to be mounted to, and along, the elongated length of the second elongated assembly; and
said elongated member defining, at least in part, spaced-apart grooves serially aligned along the elongated length of the said elongated member.

7. The apparatus of claim 3, wherein:
the complementary engagement feature is also configured to be selectively engageable with, and selectively disengageable from, said selectable engagement feature between:
an intimate secured contact engagement in which a portion of the complementary engagement feature engages, at least in part, with a portion of the selectable engagement feature thereby halting, at least in part, relative movement between the first elongated assembly and the second elongated assembly; and
a non-contact engagement in which the complementary engagement feature remains unengaged with said selectable engagement feature to permit relative movement between the first elongated assembly and the second elongated assembly.

8. The apparatus of claim 3, wherein:
said selectable engagement feature of said spaced-apart engagement features is sized to be proximately larger than the complementary engagement feature to facilitate movement of the complementary engagement feature into, at least in part, said selectable engagement feature.

9. The apparatus of claim 3, wherein:
said spaced-apart engagement features include:
an elongated member being configured to be attached, at least in part, to the second structural members of the second elongated assembly; and
the elongated member defining, at least in part, spaced-apart grooves aligned along the elongated length of the elongated member.

10. The apparatus of claim 3, wherein:
the complementary engagement feature includes:
a first frame assembly configured to be fixedly attached to the first elongated assembly; and
a second frame assembly being configured to be movable relative to the first frame assembly.

11. The apparatus of claim 10, wherein:
the complementary engagement feature further includes:
a shaped member operatively mounted to the first frame assembly;
the shaped member being configured to be movable into said selectable engagement feature; and
the shaped member also being configured to be movable out from said selectable engagement feature.

12. The apparatus of claim 11, wherein:
the shaped member is pivotally mounted to the first frame assembly.

13. The apparatus of claim 11, wherein:
the complementary engagement feature further includes:
an actuator assembly being configured to actuate selective movement of the shaped member into, and out from, said selectable engagement feature.

14. The apparatus of claim 13, wherein:
the actuator assembly includes:
a spring assembly being configured to be selectively compressed and decompressed; and
the spring assembly also being configured to biasedly engage, at least in part, a portion of the complementary engagement feature with a portion of said selectable engagement feature.

15. The apparatus of claim 14, wherein:
the actuator assembly further includes:
a tension line being configured to be coupled to the spring assembly; and
wherein in response to increased tension in the tension line, the spring assembly becomes compressed to securely engage the complementary engagement feature with said selectable engagement feature; and
wherein in response to decreased tension in the tension line, the spring assembly becomes relaxed to thereby disengage the complementary engagement feature with the selectable engagement feature.

16. The apparatus of claim 15, wherein:
the spring assembly is also configured to securely biasedly engage the complementary engagement feature with said selectable engagement feature in response to an increase in tension of the tension line in such a way that the spring assembly, in use, urges said complementary engagement feature to securely engage the selectable engagement feature to halt, at least in part, relative movement between the first elongated assembly and the second elongated assembly.

17. The apparatus of claim 16, wherein:
the complementary engagement feature further includes:
a linkage assembly being configured to link, either directly or indirectly, the complementary engagement feature with the spring assembly;
wherein the linkage assembly is configured to urge the complementary engagement feature to move away from said selectable engagement feature in response to reduction in tension of the tension line; and
wherein the linkage assembly is also configured to securely engage, in cooperation with the spring assembly, the complementary engagement feature with said selectable engagement feature in response to an application of tension to the tension line.

18. An apparatus usable with a first elongated assembly, and the apparatus also usable with a second elongated assembly being movable, at least in part, along an elongated movement axis, relative to the first elongated assembly, the apparatus also usable with spaced-apart engagement features including a selectable engagement feature, and are serially positionable, one after another, in a spaced-apart close intimate arrangement, and also said spaced-apart engagement features being coaxially alignable, at least in part, along said elongated movement axis, the apparatus comprising:
a brake assembly including a complementary engagement feature being configured to be selectively securely engageable with said selectable engagement feature; and
the complementary engagement feature also being configured to halt, at least in part, relative movement between the second elongated assembly and the first elongated assembly in response to selective secured engagement between the complementary engagement feature said selectable engagement feature.

19. The apparatus of claim 18, wherein:
said spaced-apart engagement features including spaced-apart grooves defined by an elongated member; and
the first elongated assembly and the second elongated assembly become selectively securely engageable together at said selectable engagement feature in response to the complementary engagement feature, in use, selectively securely engaging with said selectable engagement feature to thereby halt, at least in part, relative movement between the second elongated assembly and the first elongated assembly;
the spaced-apart engagement features are fixedly mounted to the second elongated assembly; and
the complementary engagement feature is fixedly mounted to the first elongated assembly.

20. An apparatus, comprising:
a first elongated assembly having first structural members, and also having an elongated longitudinal axis extending along an elongated length of the first elongated assembly;
a second elongated assembly having second structural members, and the second elongated assembly being configured to be telescopically extendable and movable relative to the first elongated assembly along an elongated movement axis being coaxially aligned relative to the elongated longitudinal axis of the first elongated assembly; and
a brake assembly including spaced-apart engagement features having a selectable engagement feature;
the spaced-apart engagement features being configured to be serially linearly securely located and positioned, at least in part, in a spaced-apart close intimate arrangement longitudinally along at least some of said second structural members of the second elongated assembly; and
the spaced-apart engagement features having spaced-apart grooves being configured to be, at least in part, coaxially aligned relative to the elongated movement axis;
said spaced-apart engagement features including:
an elongated member being configured to be attached, at least in part, to the second structural members of the second elongated assembly;
the elongated member defining said spaced-apart grooves aligned along a length of the elongated member;
the brake assembly also including a complementary engagement feature being configured to be securely supported by the first structural members of the first elongated assembly;
the complementary engagement feature being selectively securely engageable to said selectable engagement feature of said spaced-apart engagement features in such a way that selective secured engagement of the complementary engagement feature with said selectable engagement feature, in use, halts, at least in part, relative movement between the second elongated assembly and the first elongated assembly;
the complementary engagement feature is configured to apply a halting force to the selectable engagement feature;
the complementary engagement feature is also configured to be coupled to a tension line;
the complementary engagement feature includes:
a first frame assembly configured to be fixedly attached to the first elongated assembly; and
a second frame assembly being configured to be movable relative to the first frame assembly; and
the complementary engagement feature further includes:
a shaped member operatively mounted to the first frame assembly;
the shaped member being configured to be movable into said selectable engagement feature;
the shaped member also being configured to be movable out from said selectable engagement feature; and
the shaped member is pivotally mounted to the first frame assembly;
the complementary engagement feature further includes:
an actuator assembly being configured to actuate selective movement of the shaped member into, and out from, said selectable engagement feature;
the actuator assembly including:
a spring assembly being configured to be selectively compressed and decompressed; and
the spring assembly also being configured to biasedly engage a portion of the complementary engagement feature with a portion of said selectable engagement feature;
wherein in response to increased tension in the tension line, the spring assembly becomes compressed to thereby securely engage the complementary engagement feature with said selectable engagement feature; and
wherein in response to decreased tension in the tension line, the spring assembly becomes relaxed to thereby disengage the complementary engagement feature with the selectable engagement feature;
wherein the spring assembly is also configured to biasedly disengage the complementary engagement feature away from said selectable engagement feature in response to reduction in tension, at least in part, of the tension line in such a way that the spring assembly, in use, urges the complementary engagement feature away from the selectable engagement feature to permit relative movement between the first elongated assembly and the second elongated assembly; and
wherein the spring assembly is also configured to securely biasedly engage the complementary engagement feature with said selectable engagement feature in response to an increase in tension of the tension line in such a way that the spring assembly, in use, urges said complementary engagement feature to securely engage the selectable engagement feature to halt, at least in part, relative movement between the first elongated assembly and the second elongated assembly;
the complementary engagement feature further includes:
a linkage assembly being configured to link, either directly or indirectly, the complementary engagement feature with the spring assembly;
the linkage assembly also being configured to urge movement of the complementary engagement feature away from said selectable engagement feature in response to reduction in tension of the tension line; and
the linkage assembly is also configured to securely engage, in cooperation with the spring assembly, the complementary engagement feature with said selectable engagement feature in response to an application of tension to the tension line.
